(19) United States
(12) Patent Application Publication
(10) Pub. No.: US 2026/0278284 A1
(43) Pub. Date: Sep. 17, 2026

(54) SYSTEM

(71) Applicant: SoftBank Group Corp., Tokyo (JP)

(72) Inventor: Shintaro WAKI, Tokyo (JP)

(73) Assignee: SoftBank Group Corp., Tokyo (JP)

(21) Appl. No.: 19/549,214

(22) Filed: Feb. 25, 2026

Related U.S. Application Data
(60) Provisional application No. 63/771,090, filed on Mar. 13, 2025.

(51) Int. Cl. G06F 40/35; G06F 40/40; G10L 13/033; G10L 15/02; G10L 15/16; G10L 15/26; G10L 25/63

(52) U.S. Cl. CPC G06F 40/35; G06F 40/40; G10L 13/033; G10L 15/02; G10L 15/16; G10L 15/26; G10L 25/63; G10L 2015/025

(57) ABSTRACT

A system includes a processor that is configured to control an audio input unit including a microphone to acquire a spoken utterance of a user as audio data, analyze the acquired audio data by using a generative artificial intelligence model included in a dialect recognition unit to convert a dialect or accent included in the utterance into standard language text data, process the standard language text data by using natural language processing techniques included in a response generation unit to understand an intention of the user and to generate an appropriate response text, and control an audio output unit to convert the generated response text into natural speech by using a speech synthesis technique and to reproduce the natural speech through a speaker.

### CROSS-REFERENCE TO RELATED APPLICATION

This application claims the benefit of U.S. Provisional Application No. 63/771,090 filed on Mar. 13, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

### SUMMARY

The term “processor” refers to one or more hardware processing units, such as a CPU, GPU, or dedicated accelerator, which execute instructions to control the functions of the system and its components.

The term “audio input unit” refers to a hardware and software module configured to capture sound from the environment, including at least one microphone and associated circuitry and processing for acquiring a user's spoken utterance as audio data.

The term “microphone” refers to a transducer that converts sound waves, including a user's speech, into electrical signals or digital audio data for further processing by the system. The term “audio data” refers to digital information representing sound, including sampled and quantized representations of a user's spoken utterances.

The term “dialect recognition unit” refers to a functional module, implemented by hardware and software under control of the processor, that analyzes audio data and converts speech containing dialects or accents into standardized text.

The term “dialect or accent” refers to region-specific or group-specific variations of a language, including characteristic pronunciation, vocabulary, and expressions that differ from a corresponding standard language form.

The term “standard language text data” refers to text data representing speech in a standardized or common variety of a language, obtained by converting or normalizing dialectal or accented speech into the standard form.

The term “generative artificial intelligence model” refers to a machine learning model, such as a neural network trained on large datasets, that can generate or transform data, including converting dialectal speech representations into standardized text or generating response text from input text.

The term “response generation unit” refers to a functional module, implemented by hardware and software under control of the processor, that uses natural language processing techniques to understand a user's intention from text data and to generate an appropriate response text. The term “natural language processing techniques” refers to algorithms and models for analyzing, interpreting, and generating human language, including tasks such as intent detection, entity extraction, context analysis, and response text generation.

The term “intention of the user” refers to the underlying meaning, purpose, request, or communicative goal expressed by the user's spoken utterance as interpreted by the system. The term “response text” refers to text data representing a linguistic reply generated by the system in response to a user's utterance.

The term “audio output unit” refers to a hardware and software module configured to output sound to the user, including conversion of response text into speech and playback of the resulting audio through a speaker.

The term “speech synthesis technique” refers to a method or algorithm, including text-to-speech technology, that converts text data into synthetic speech signals.

The term “natural speech” refers to synthesized audio that is generated to resemble human speech in terms of pronunciation, prosody, intonation, and timing, so as to be easily understandable and comfortable for a listener.

The term “speaker” refers to an electroacoustic transducer that converts electrical or digital audio signals into audible sound waves perceivable by the user.

The term “speech model” refers to a machine-learned model trained on speech data, used to recognize, analyze, or map acoustic features of spoken language, including dialect-specific characteristics.

The term “phoneme level analysis” refers to processing that analyzes speech at the level of phonemes, which are the smallest units of sound that distinguish meaning in a language.

The term “dialect-specific pronunciations and vocabulary” refers to pronunciations, words, and expressions that are characteristic of a particular dialect or accent and differ from those used in the standard language.

The term “mapping to the standard language text data” refers to the process of converting dialect-specific pronunciations and vocabulary into corresponding expressions in the standard language, resulting in standardized text output.

The term “context” refers to information surrounding a user's utterance, including preceding and subsequent utterances, environmental conditions, and related data that influence interpretation of the user's intention.

The term “past dialogue history” refers to stored records of previous interactions between the user and the system, including prior utterances, recognized text, detected intentions, and generated responses.

The term “predefined response templates” refers to pre-authored sentence patterns or text structures stored in a database, which the system can select or fill with variable information to generate response text.

The term “database” refers to a structured data storage system that holds information such as response templates, user profiles, dialogue history, and external data used by the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

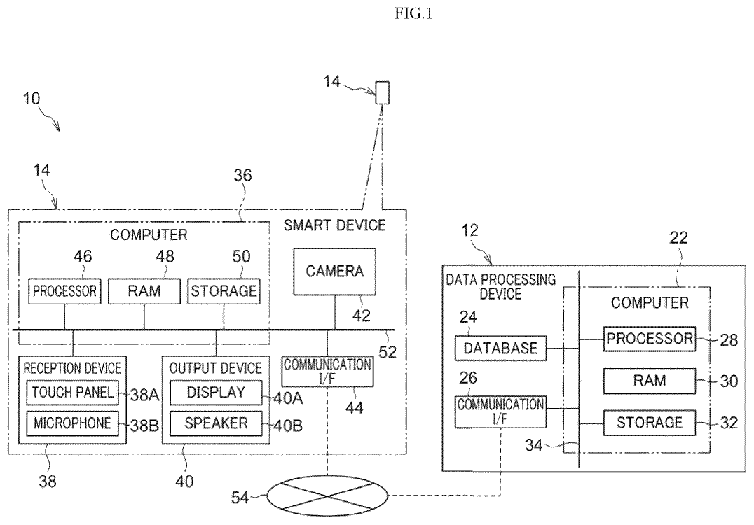

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

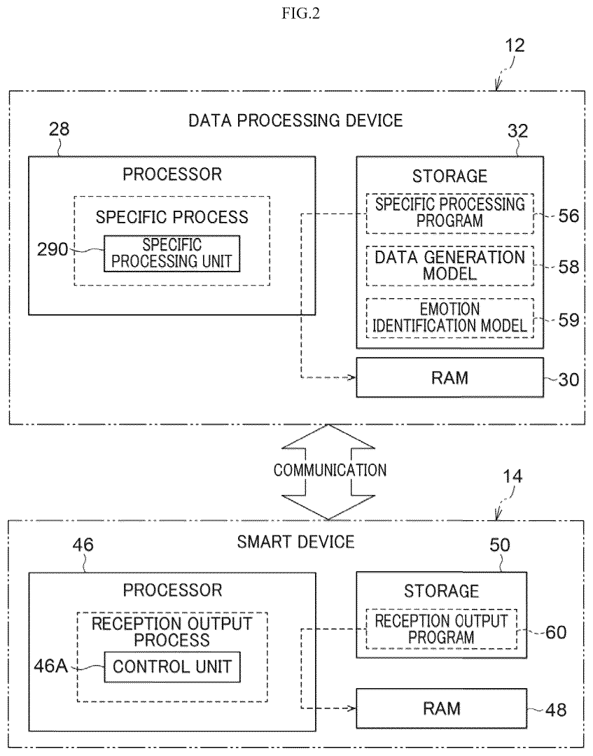

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional dialogue systems that support elderly users in care facilities typically assume that user utterances are provided in a standard language and that simple rule-based or template-based response generation is sufficient. However, in practice, users often speak in strong regional dialects, exhibit age-related speech characteristics, and require highly contextual and empathetic responses. Existing systems that merely apply generic speech recognition and generic natural language processing frequently misrecognize dialect expressions, fail to correctly infer user intent, and generate responses that are unnatural or inappropriate in context. As a result, such systems degrade the quality of human-computer interaction and increase the burden on caregivers who must compensate for these deficiencies. Furthermore, many known architectures perform speech recognition, language understanding, and response generation as isolated components, without coordinated control of generative AI models via explicit prompt sentences. In these architectures, each model operates on limited input signals and is not systematically guided by structured context information such as user profiles, dialogue histories, or environment information. This leads to inefficient use of computing resources, suboptimal model outputs, and difficulty in adapting the system to facility-specific communication patterns. Additionally, conventional systems rarely record and exploit detailed processing histories to update model behavior and prompt configurations over time, which limits continuous learning and improvement.

There is thus a need for an improved computer-implemented dialogue system that (i) robustly handles regional dialects and accents at scale, (ii) centrally orchestrates dialect conversion and response generation using generative AI models controlled by explicit prompt sentences, (iii) integrates rich context information into the prompts to improve the accuracy and appropriateness of generated outputs, and (iv) continuously updates models and prompt sentences based on accumulated processing history. Such a system should technically improve the functioning of the underlying computing platform by reducing recognition errors, reducing unnecessary computation due to failed interactions, and enhancing the reliability and efficiency of end-to-end human-machine dialogue in resource-constrained care environments.

The specific processing by the specific processing unit 290 of the data processing device 12 in Example 1 is realized by the following means.

The present invention provides a server comprising a processor configured to receive audio information representing a user utterance from a terminal device via a communication network, convert the audio information into dialect text information, generate a first prompt sentence for a generative AI model so as to convert a dialect contained in the dialect text information into a standard language, cause the generative AI model to generate standard-language text information based on the dialect text information and the first prompt sentence, obtain context information including at least user intention, user information, and dialogue history information based on the standard-language text information, generate a second prompt sentence including the context information for the generative AI model, cause the generative AI model to generate a response sentence based on the standard-language text information and the second prompt sentence, transmit the response sentence or audio information based on the response sentence to the terminal device via the communication network, and store processing history including at least one of speech recognition processing, dialect conversion processing, intention estimation processing, and response generation processing, and update at least one of the generative AI model and at least one of the first prompt sentence and the second prompt sentence based on accumulated processing history. This enables an improvement in computer technology by coordinating speech recognition, dialect normalization, intent understanding, and response generation under unified control of the processor through structured prompt sentences, thereby enhancing recognition robustness for dialectal speech, improving the contextual accuracy and safety of generated responses, reducing processing inefficiencies caused by misinterpretation of user utterances, and allowing the server to adapt its generative AI behavior over time based on stored processing histories.

The term “audio information” refers to digital data representing sound, including but not limited to sampled and quantized waveforms of a user utterance, which can be processed by a computing device for analysis, recognition, or synthesis.

The term “user utterance” refers to spoken content produced by a human user, including words, phrases, and sentences, which is captured as audio information by an input device. The term “terminal device” refers to an electronic apparatus operated by or located near a user, such as a portable or stationary computing device, that comprises at least an audio input unit and an audio output unit and is configured to communicate with a server via a communication network.

The term “audio input unit” refers to a hardware and software combination in the terminal device that captures sound, including at least one microphone and associated signal processing logic for acquiring audio information representing a user utterance.

The term “audio output unit” refers to a hardware and software combination in the terminal device that outputs sound, including at least one speaker and associated signal processing logic for reproducing synthesized speech based on response sentences.

The term “information processing device” refers to a computing apparatus such as a server that includes at least one processor and memory and is configured to execute software components that perform speech recognition processing, dialect conversion processing, intent estimation processing, response generation processing, and related control functions. The term “communication network” refers to a wired or wireless data transmission infrastructure, including any combination of local networks and wide-area networks, that enables exchange of information between the terminal device and the information processing device.

The term “dialect text information” refers to character-based data obtained by converting audio information representing a user utterance into textual form, where the text includes expressions in one or more regional dialects or accents of a language.

The term “standard-language text information” refers to character-based data representing a user utterance that has been converted from a dialectal or accented form into a standard or reference form of the same language according to predetermined linguistic rules or models. The term “generative AI model” refers to a machine-learned model, such as a neural network-based language model, configured to generate output data including at least text or audio based on input data and one or more prompt sentences, by probabilistically predicting sequences of tokens or other data units.

The term “prompt sentence” refers to a textual instruction or set of instructions provided to a generative AI model, which specifies at least a task, constraints, or context for the generative AI model and conditions the model's output based on the content of the prompt.

The term “first prompt sentence” refers to a prompt sentence that is specifically constructed to cause the generative AI model to convert dialect text information into standard-language text information.

The term “second prompt sentence” refers to a prompt sentence that is specifically constructed to cause the generative AI model to generate a response sentence based at least on standard-language text information and context information including user information and dialogue history information.

The term “context information” refers to structured or unstructured data associated with a user utterance, including at least user intention, user information, dialogue history information, and optionally environment information, that is used to condition processing by the generative AI model.

The term “user intention” refers to an inferred communicative goal or purpose of a user utterance, such as a request, complaint, comment, or question, identified by natural language understanding or similar analysis.

The term “user information” refers to data describing attributes of a user, including but not limited to demographic data, health-related notes, preferences, and any other profile information stored in association with the user.

The term “dialogue history information” refers to data representing past interactions between a user and the system, including prior user utterances, system responses, timestamps, and related metadata, stored for use in subsequent processing steps.

The term “environment information” refers to data obtained from external information sources that describes a condition or context outside the user and the system, including but not limited to weather information, time of day, or facility status.

The term “response sentence” refers to text generated by the generative AI model or by other processing components that represents an output message of the system intended to be provided to the user as part of a dialogue.

The term “synthetized speech” refers to audio information generated by a text-to-speech or other speech synthesis technique, which converts a response sentence into a waveform suitable for playback by a speaker.

The term “emotion and intonation” refers to prosodic characteristics of synthesized speech, including pitch, loudness, rhythm, speaking rate, and tonal patterns, which are controlled to express an affective or conversational style.

The term “speech recognition processing” refers to computational operations that convert audio information into text, including feature extraction, acoustic modeling, decoding, and any associated post-processing.

The term “dialect conversion processing” refers to computational operations that transform text containing dialectal or accented expressions into standard-language text information, using at least the generative AI model and one or more prompt sentences.

The term “intention estimation processing” refers to computational operations that infer user intention from text, context information, or other signals, including classification, entity extraction, and context-aware interpretation.

The term “response generation processing” refers to computational operations that produce a response sentence based on standard-language text information, context information, and at least one prompt sentence supplied to the generative AI model.

The term “processing history” refers to stored data describing one or more past executions of speech recognition processing, dialect conversion processing, intention estimation processing, or response generation processing, including inputs, outputs, and associated metadata. The term “accumulated processing history” refers to a collection of processing history records stored over time and used for subsequent analysis, adaptation, or learning.

The term “update” refers to modification of parameters, configuration, or behavior of at least one of the generative AI model or at least one of the first prompt sentence and the second prompt sentence, based on accumulated processing history or other criteria.

The term “acoustic model” refers to a statistical or machine-learned model that represents relationships between audio features and linguistic units such as phonemes, and is used in speech recognition or dialect processing.

The term “language model” refers to a statistical or machine-learned model that represents probabilities or patterns of sequences of linguistic units such as characters, words, or tokens, and is used in decoding or text generation.

The term “audio feature information” refers to data derived from audio information, including but not limited to spectral coefficients, mel-frequency representations, energy, and temporal features, used by an acoustic model or other processing modules.

The term “target region” refers to a geographic or linguistic classification used to specify a particular regional dialect or accent that is to be handled or converted during dialect conversion processing.

The term “dialect type” refers to a classification of a dialect or accent within a language, such as a regional, social, or stylistic variety, used to guide conversion to a standard language. The term “conversion policy” refers to a set of rules or preferences that control how dialect text information is transformed into standard-language text information, including target politeness level, formality level, or preservation of nuances.

The term “safety” refers to characteristics of a response sentence that avoid harmful, offensive, or inappropriate content, determined according to predetermined safety criteria or filters.

The term “expression style” refers to linguistic and stylistic properties of a response sentence, including politeness level, complexity, tone, and register, which can be constrained or modified by the system.

In one embodiment, a server and one or more terminals cooperate to implement a dialogue system that converts dialectal speech of a user into standard-language text, generates context-aware responses by means of a generative AI model controlled through explicit prompt sentences, and outputs synthesized speech with controlled prosody. A user interacts with the system primarily via the terminal, which acquires and reproduces audio, while the server performs high-load recognition, language conversion, and response generation processing.

A terminal includes at least one processor, a memory, a microphone as an audio input unit, a speaker as an audio output unit, and a communication interface such as a wireless network interface. The terminal executes an operating system such as a general-purpose mobile or embedded operating system, and executes application software that communicates with the server. In one configuration, the terminal uses a microphone array and an audio processing library such as a noise suppression library compatible with a real-time communication framework to perform local denoising and echo cancellation before transmitting audio information. The terminal stores raw audio samples in a circular buffer in memory and applies fixed-point or floating-point signal processing routines to normalize amplitude and remove stationary noise. By performing at least part of this processing locally, the terminal reduces the bandwidth required for transmission to the server and improves the signal-to-noise ratio at the server side, which directly contributes to improved recognition accuracy.

The server includes at least one general-purpose processor, a main memory, a non-volatile storage device, and a network interface. The server executes system software such as a general-purpose server operating system and application software that realizes functions of speech recognition, dialect conversion, natural language understanding, response generation, and model adaptation. The server stores in the non-volatile storage device model parameters for one or more neural network models, including an automatic speech recognition model, an acoustic model, a language model, and at least one generative AI model configured as a transformer-based language model.

The server uses the automatic speech recognition model to convert audio information received from the terminal into dialect text information. In one implementation, the server uses a neural network that receives as input a sequence of acoustic feature vectors, such as log-Mel spectrogram frames, and outputs a sequence of probability distributions over subword units. The server uses a decoding algorithm such as beam search constrained by a language model to obtain a most probable sequence of tokens representing the user utterance, which may contain dialectal expressions. The acoustic model may have a multi-layer architecture including convolutional layers for local feature extraction, followed by self-attention layers for long-range temporal modeling. The language model may be implemented as a recurrent or transformer-based network trained on domain-specific corpora that include regional dialect data.

The server uses the dialect text information, in which regional dialect expressions remain, to construct a first prompt sentence for a generative AI model that performs dialect conversion. In one example, the server constructs a prompt sentence such as:

“You are a Japanese language assistant. Convert the following Japanese utterance from a regional dialect into polite standard Japanese. Preserve the original meaning. Focus on Kansai and Tohoku dialects. Utterance: “It's really hot today.” Output only the converted sentence.”

The server concatenates the first prompt sentence and the dialect text information into a token sequence and supplies the sequence to the generative AI model. The generative AI model may have a transformer architecture including an embedding layer, multiple self-attention layers, feed-forward layers, and a final projection layer. The server performs tokenization by mapping characters or subword units to integer token identifiers and stores the sequence in memory as an array of integers. The server performs inference by executing matrix multiplications and non-linear activation functions using numerical libraries optimized for a processor or an accelerator. The server derives standard-language text information such as “It is very hot today.” by decoding the output token probabilities into a sequence of tokens via greedy decoding or beam search. By structuring the processing in this manner, the server converts dialect text information into a standardized representation that downstream components can process more reliably, thereby reducing error propagation and improving the overall processing accuracy.

The server uses the standard-language text information to determine context information that includes at least user intention, user information, and dialogue history information. The server stores user information and dialogue history information in a database system as structured records. The server may represent a user profile as a record including fields such as user identifier, age, health notes, communication preferences, and language characteristics. The server may represent dialogue history information as a time-ordered list of records, each record including a timestamp, user utterance text, system response text, and processing metadata such as model versions and confidence scores. By maintaining these data structures, the server can retrieve relevant prior interactions and user attributes efficiently using indexed queries.

The server applies a natural language understanding module to the standard-language text information to estimate user intention and extract entities. The server may use a classifier based on a neural network, such as a transformer encoder, that receives as input the tokenized standard-language text and outputs an intention label and entity spans. The server calculates an intention vector representation in a latent space and classifies it into categories such as “comment on environment,” “health-related concern,” or “request for assistance.” Because the server operates on standardized text rather than raw dialectal text, the classifier can be trained on a more uniform dataset, resulting in improved classification accuracy and reduced model complexity.

The server integrates the standard-language text information, user information, dialogue history information, and optionally external environment information such as weather data into context information. The server may represent the context information as a structured object containing fields for each type of information. The server then constructs a second prompt sentence that includes at least part of the context information. In one example, the server constructs a second prompt sentence such as:

“You are an assistant speaking polite, easy-to-understand Japanese for elderly users in a care facility.

Task: Generate a short, empathetic response based on the information below.

Constraints: Be kind, avoid technical terms, and use standard Japanese.

User utterance: “It is very hot today.”

User profile: 82-year-old male, history of dehydration, living in a care facility.

Recent dialogue: “I felt a bit unwell yesterday as well.”

Weather information: 34° C., high humidity.

Output: A single conversational sentence in Japanese.”

The server supplies the second prompt sentence, together with the standard-language text information and context information, to the generative AI model. The same generative AI model as used for dialect conversion may be reused in a different prompting configuration or a different language model may be used. The server executes the transformer layers to compute attention over the combined tokens of the second prompt sentence and the standard-language text information, thereby enabling the generative AI model to consider the user's utterance, user profile, dialogue history, and environment information simultaneously. By explicitly encoding such information into the second prompt sentence and internal token sequence, the server directs the generative AI model to generate responses that are both contextually appropriate and tailored to the user's situation.

The server generates a response sentence such as “Yes, as it is particularly hot today, please take fluids frequently.” and then applies a filtering process to ensure safety and expression style. The server may apply a rule-based post-processing module that examines the response sentence for prohibited terms, inappropriate expressions, or excessive length, and may re-invoke the generative AI model with a revised second prompt sentence if necessary. This filtering process is performed by explicit text analysis algorithms and rule sets, not by an implicit or undefined “judgment” of the model.

The server transmits the response sentence or pre-synthesized audio information to the terminal via the communication network. If the response sentence is transmitted in text form, the terminal locally executes a text-to-speech engine. In one embodiment, the terminal uses a neural speech synthesis model such as an encoder-decoder network that converts text into a mel-spectrogram and a vocoder network that converts the mel-spectrogram into waveform samples. The terminal controls prosodic parameters such as speaking rate, pitch, and energy based on metadata included in the message from the server, for example specifying that the tone should be “warm” and “slow.” Alternatively, the server may generate the audio waveform and send it to the terminal if the terminal has limited computational resources. The terminal uses the audio output unit to play the synthesized speech through the speaker. The terminal may also adjust output gain and dynamic range based on environmental noise measured by the microphone. Because the server and terminal cooperate in this manner, the system dynamically adjusts both analysis and synthesis parameters in response to current conditions, which provides technical effects such as improved intelligibility for the user and reduced need for repeated utterances.

The server stores processing history that includes at least speech recognition processing, dialect conversion processing, intention estimation processing, and response generation processing. The server records, in a log database, for each interaction, the input audio information identifier, the recognized dialect text information, the standard-language text information, the first prompt sentence, the second prompt sentence, model versions, and metrics such as confidence scores or user feedback flags. The server uses these logs in offline or online training procedures to update the model parameters and refine the prompt sentences. For example, the server may perform fine-tuning of the generative AI model using supervised learning, where the loss function includes a cross-entropy term between the generated token distribution and target text, regularization terms for model stability, and additional penalties for undesired stylistic characteristics. The server updates the model weights by gradient-based optimization, such as stochastic gradient descent or an adaptive method, and stores the updated model in non-volatile storage for subsequent inference.

The server also adjusts the first and second prompt sentences based on the accumulated processing history. For instance, if the log indicates systematic errors in converting a particular regional dialect, the server may insert additional instructions into the first prompt sentence, such as “Pay particular attention to expressions used in the western region and convert them into polite standard Japanese.” If the log indicates that responses are too long for certain users, the server may modify the second prompt sentence to include a constraint such as “Use no more than two short sentences.” In this way, the server applies explicit rule-based updates to the textual prompt sentences according to measured performance, thereby changing the behavior of the generative AI model without retraining in some cases. This combination of model parameter updates and prompt adaptation results in improved recognition robustness, response quality, and computational efficiency, and is not a mere automation of human operation but a technical improvement of the computing system itself.

The described architecture improves computer technology under several aspects. First, by performing dialect conversion in a separate stage using a generative AI model guided by a dedicated prompt sentence, the server provides a normalized text representation that reduces the complexity of downstream intent estimation models. This leads to fewer parameters, reduced memory usage, and faster inference in the intent estimation processing. Second, by explicitly incorporating structured context information into the second prompt sentence and internal data structures, the server enables the generative AI model to use longer-range contextual information than conventional systems that only process the current utterance, thereby reducing the need for repeated queries or fallback responses and lowering overall traffic and computation. Third, by logging detailed processing history and using that history to refine models and prompt sentences, the server adapts its operations in a data-driven manner that exploits statistical properties of interactions, leading to lower error rates and reduced processing time for typical inputs over the lifetime of the system.

The server and the terminal thus realize a particular machine that executes a specific combination of algorithms and data flows, including neural network inference, prompt construction, rule-based filtering, and adaptive model updating. The server and terminal do not merely implement an abstract mental process but transform physical signals (audio waveforms) into different forms (standard-language text, synthesized speech) and control hardware components (microphones, speakers, network interfaces) in a manner that is specifically configured to address the technical challenges of dialectal speech recognition, low-resource terminal environments, and elderly users' communication needs.

In another embodiment, the server may distribute some of the processing functions to the terminal. For example, the terminal may execute a lightweight automatic speech recognition model to generate preliminary text information, and the server may then perform refined dialect conversion and response generation. In yet another embodiment, the server may deploy separate generative AI models for dialect conversion and response generation, each trained on different datasets and with different architectures or hyperparameters, while maintaining the structure of first and second prompt sentences as described. The system may also support different languages by switching the acoustic models, language models, and prompt templates accordingly, while preserving the overall interaction pattern between the server and the terminal.

The user interacts with the system by speaking naturally in a dialect. The user does not need to operate complex interfaces or adapt speech patterns intentionally. The terminal and the server, through the described hardware components and software modules, carry out a sequence of processing steps that include signal acquisition, denoising, recognition, dialect conversion, context integration, generative response creation, filtering, and synthesis, all of which are concretely implemented by algorithms and data structures as described. This configuration allows the system to provide reliable, responsive, and contextually appropriate dialogue support in real-world care facilities, with technical effects in terms of improved speech recognition robustness, reduced computational waste, and adaptive performance enhancement over time.

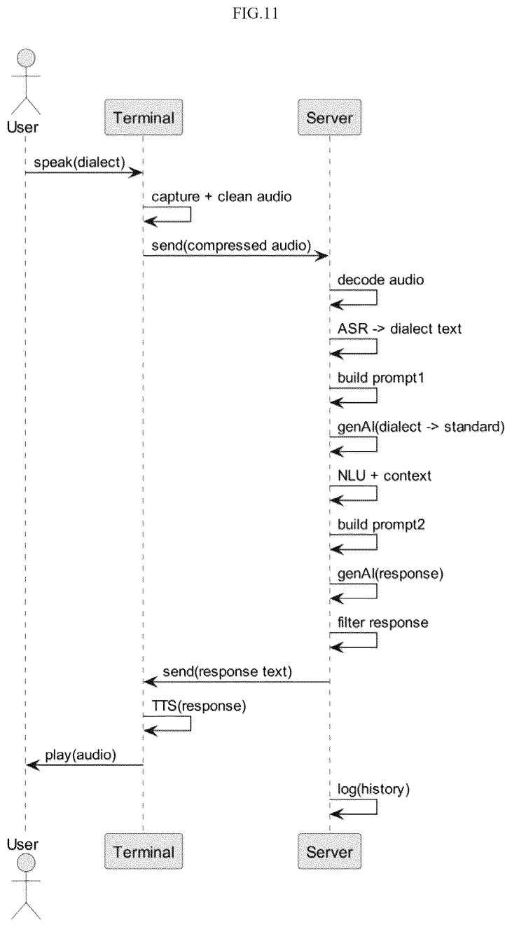

The following describes the processing flow using FIG. 11.

### Step 1:

The user speaks a natural utterance including a dialect toward the terminal.

The input is an acoustic sound wave in air.

The terminal converts the analog signal from the microphone into digital audio samples (for example, 16-bit PCM at 16 kHz) using an analog-to-digital converter and stores the samples in a buffer in memory.

The terminal applies noise suppression and echo cancellation to the buffer using an audio processing library, and the output is cleaned audio data with reduced background noise and reduced acoustic echo.

### Step 2:

The terminal analyzes the cleaned audio data to detect speech segments.

The input is the cleaned audio data from Step 1.

The terminal executes a voice activity detection algorithm that computes short-time energy and spectral features for each frame, compares them with preset thresholds, and classifies frames as speech or non-speech.

The terminal concatenates consecutive speech frames, discards non-speech frames, and the output is segmented speech audio suitable for transmission and recognition.

### Step 3:

The terminal compresses the segmented speech audio and transmits it to the server. The input is the segmented speech audio from Step 2.

The terminal encodes the audio using a lossy audio codec (for example, a perceptual encoder) that transforms each frame into a frequency representation, applies psychoacoustic masking, quantizes coefficients, and packs them into compressed frames.

The terminal adds timestamps and a session identifier to each compressed frame, encapsulates the frames into network packets, and sends the packets through a communication interface over a communication network; the output is a sequence of compressed audio packets received by the server.

### Step 4:

The server receives and reconstructs the compressed audio stream.

The input is the sequence of compressed audio packets from Step 3.

The server reorders packets based on timestamps, verifies the session identifier, and concatenates the payloads into a continuous compressed bitstream.

The server decodes the bitstream using a decoder that reverses the codec operations, reconstructing linear PCM audio; the output is normalized audio data ready for speech recognition.

### Step 5:

The server performs automatic speech recognition to obtain dialect text information.

The input is the normalized audio data from Step 4.

The server divides the audio into overlapping windows, computes log-Mel spectrograms for each window, and feeds the feature matrices into a neural acoustic model composed of multiple layers of convolution and self-attention.

The server obtains, for each time step, a probability distribution over subword units, and applies a decoding algorithm such as beam search combined with a language model to select the most probable token sequence; the output is dialect text information representing the user utterance in a dialect.

### Step 6:

The server constructs a first prompt sentence and converts the dialect text information into standard-language text information using a generative AI model.

The input is the dialect text information from Step 5.

The server generates a first prompt sentence as a text string, for example:

“You are a Japanese language assistant. Convert the following Japanese utterance from a regional dialect into polite standard Japanese. Preserve the original meaning. Focus on Kansai and Tohoku dialects. Utterance: “It's really hot today.” Output only the converted sentence.” The server concatenates the first prompt sentence and the current dialect text into a single input text, tokenizes the text into token identifiers, and supplies the sequence to a transformer-based generative AI model.

The generative AI model computes contextual embeddings via stacked self-attention layers and generates output token probabilities; the server decodes these probabilities into a token sequence and converts it back to characters; the output is standard-language text information such as “It is very hot today.”

### Step 7:

The server derives context information including user intention, user information, and dialogue history information.

The input is the standard-language text information from Step 6 and stored data in a database.

The server passes the standard-language text to an intent classifier that encodes the text with a transformer encoder, computes an intent vector, and classifies it into an intent label (for example, “comment on weather”).

The server queries a user profile table using a user identifier to retrieve user information, and queries a dialogue history table to retrieve recent utterances and responses.

The server combines the intent label, user information fields, dialogue history entries, and optionally environment information such as current weather into a structured context object; the output is context information associated with the utterance.

### Step 8:

The server constructs a second prompt sentence and generates a response sentence using the generative AI model.

The input is the standard-language text information from Step 6 and the context information from Step 7.

The server assembles a second prompt sentence in natural language, for example:

“You are an assistant speaking polite, easy-to-understand Japanese for elderly users in a care facility.

Task: Generate a short, empathetic response based on the information below.

Constraints: Be kind, avoid technical terms, and use standard Japanese.

User utterance: “It is very hot today.”

User profile: 82-year-old male, history of dehydration, living in a care facility.

Recent dialogue: “I was feeling slightly unwell yesterday.”

Weather information: 34° C., high humidity.

Output: A single conversational sentence in Japanese.”

The server concatenates the second prompt sentence and the standard-language text, tokenizes the combined text, and feeds the token sequence to the generative AI model.

The generative AI model performs attention over all tokens, generates a new sequence of tokens corresponding to a response, and the server decodes the tokens into a response sentence; the output is response text such as “Yes, as it is particularly hot today, please take fluids frequently.”

### Step 9:

The server filters and finalizes the response sentence.

The input is the response sentence from Step 8.

The server executes a rule-based safety and style filter that scans the response text for prohibited expressions, checks length limits, and verifies politeness level using pattern matching and scoring rules.

If the server detects a violation, the server either modifies specific parts of the response according to replacement rules or regenerates the response by updating constraints in the second prompt sentence and repeating Step 8.

The output is a finalized response sentence that satisfies predefined safety and expression-style criteria.

### Step 10:

The server transmits the finalized response data to the terminal.

The input is the finalized response sentence from Step 9.

The server encapsulates the response text and optional prosody parameters (such as desired speaking rate and tone tag) into a message structure and sends the message via the communication network to the terminal using a reliable transport protocol.

The output is a received message at the terminal containing the text response and control data for speech synthesis.

### Step 11:

The terminal synthesizes audio from the response sentence.

The input is the received message from Step 10 containing the response text and prosody parameters.

The terminal passes the text to a text-to-speech engine, which converts the text into a sequence of phonemes or symbols, predicts a mel-spectrogram by an encoder-decoder neural network, and generates waveform samples with a vocoder network.

The terminal adjusts pitch, speaking rate, and amplitude according to the prosody parameters provided by the server, and the output is synthesized audio data representing spoken response speech.

### Step 12:

The terminal outputs the synthesized audio to the user.

The input is the synthesized audio data from Step 11.

The terminal writes the audio data into an output buffer managed by an audio driver, schedules playback according to the system clock, and sends the samples to a digital-to-analog converter connected to the speaker.

The speaker converts the electrical signal into sound waves, and the output is audible speech that the user hears as the system's response.

### Step 13:

The server records processing history for later learning and adaptation.

The input is a set of data items generated in Steps 4 through 9, including identifiers for the audio data, dialect text information, standard-language text information, the first prompt sentence, the second prompt sentence, model version identifiers, and the finalized response sentence.

The server writes these items into a log database as structured records, including timestamps and any available feedback indicators such as error flags or correction signals from caregivers.

The output is accumulated processing history stored in persistent storage, which the server subsequently uses as training data or evaluation data to update model parameters and refine prompt sentences in offline or periodic learning processes.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional voice-based interfaces that handle dialect or region-specific spoken language mainly focus on improving recognition accuracy at the text level and generating generic conversational responses. Such systems typically separate dialect normalization, intent understanding, and downstream control logic, and they treat the language processing pipeline as a pre-processing front-end for a fixed application. As a result, these systems exhibit several technical limitations from the perspective of computer technology itself. First, conventional systems do not tightly integrate dialect normalization with domain-specific control tasks, such as automated driving control, within a unified computational architecture. Dialect recognition modules usually produce standardized text, but the downstream components for planning and control are not optimized to exploit rich, structured intent information derived from that text. This architectural gap leads to redundant processing, increased latency, and inconsistent behavior when the user's instructions are ambiguous or context-dependent.

Second, known systems rarely employ generative AI models through explicitly structured prompt sentences that are dynamically generated based on current dialog context, user attributes, and environment information. Without such dynamically controlled prompt sentences, the generative AI model behaves as a generic text generator, and its outputs are not systematically constrained to produce normalized language or structured control parameters suitable for real-time driving control. This reduces reliability and requires additional rule-based post-processing, which increases computational overhead and complexity.

Third, existing solutions do not effectively transform unstructured, dialect-rich voice input into machine-usable structured information (for example, explicit driving intent, travel priority, and route constraints) in a way that directly feeds into algorithmic planning modules. The lack of a mechanism to cause a generative AI model to output explicitly structured information, which can be consumed by route-planning and control algorithms, impairs the ability of the system to reduce processing steps, improve throughput, and enhance the determinism of the overall pipeline.

Fourth, many systems treat user interaction and driving control as loosely coupled subsystems, so explanations to the user about driving plans and reasons for specific driving actions are generated ad hoc or by templates. This separation hinders the use of internal control data (for example, driving instruction information and control results) as input to a unified generative AI pipeline, and thus prevents efficient reuse of internal computation to provide consistent and technically meaningful feedback to the user.

Accordingly, there is a need for an improved computer-implemented system and method that (i) uses a processor-controlled generative AI model with dynamically generated prompt sentences to normalize dialect and region-specific traffic terminology; (ii) extracts structured driving intent information from standardized text using the same or coordinated generative AI model; (iii) generates driving instruction information suitable for downstream route planning and driving control; and (iv) reuses this internally generated information to produce coherent, technically grounded explanations to the user. Such a system should improve the efficiency, reliability, and integration of the overall computation pipeline for automated driving and similar control tasks, thereby providing a concrete improvement in computer technology.

The specific processing by the specific processing unit 290 of the data processing device 12 in Application Example 1 is realized by the following means.

The present invention provides a server comprising a processor and a memory storing instructions which, when executed by the processor, cause the processor to acquire voice information by means of an audio information acquisition unit including at least one sound collection device that captures utterances of a user, to analyze the acquired voice information and convert region-specific spoken language into standardized spoken language by means of a language conversion unit that employs a generative AI model controlled via a dynamically generated prompt sentence, to perform semantic analysis on text information converted into standardized spoken language and extract user intent and instruction content relating to driving operations by means of an intent extraction unit that employs a natural language processing mechanism, to generate driving instruction information representing a travel route and a travel action of a moving body based on the extracted intent and instruction content by means of a driving instruction generation unit, to calculate travel control quantities of the moving body based on the driving instruction information and surrounding environment information and to output control signals for a drive device and a steering device of the moving body by means of a driving control unit, to generate the prompt sentence dynamically by means of a prompt generation unit so that the prompt sentence includes instruction content for causing the generative AI model to convert dialect and region-specific traffic terminology into standardized spoken language and instruction content for causing the generative AI model to output structured information describing driving intent and constraints from the standardized spoken language, and to generate response information explaining a travel plan and a travel reason to the user on the basis of the driving instruction information and control results of the driving control unit and to output the response information as synthesized speech. This enables the computer system to transform unstructured dialect-rich voice input into standardized and structured control information in a single integrated processing pipeline, to reduce processing latency and redundancy, to improve the determinism and reliability of driving instruction generation and execution, and to reuse internal control data for coherent user feedback, thereby providing a concrete improvement in the functioning of the computer system that implements automated driving and related control operations.

The term “voice information” refers to digital data representing sound captured from a user's utterances, including at least one of raw audio waveforms, encoded audio frames, and audio feature vectors generated by an audio front-end.

The term “audio information acquisition unit” refers to a hardware and software component that captures sound via one or more sound collection devices and converts the captured sound into voice information suitable for processing by a processor.

The term “sound collection device” refers to an electro-acoustic transducer, such as a microphone or an array of microphones, that converts acoustic signals in an environment into electrical or digital signals.

The term “region-specific spoken language” refers to spoken language variants that differ from a standardized language in pronunciation, vocabulary, or grammatical structure, including at least one of dialects, accents, and region-specific terminology.

The term “standardized spoken language” refers to a normative or common form of a language that is used as a reference for recognition, interpretation, and generation, and that excludes region-specific variations in pronunciation, vocabulary, or grammar.

The term “language conversion unit” refers to a functional component implemented by hardware and software that receives voice information or text information including region-specific spoken language and outputs text information in standardized spoken language. The term “generative AI model” refers to a machine learning model, such as a neural network based on a transformer architecture, that is trained to generate text or other data in response to input data and one or more control parameters, including prompt sentences.

The term “generative-type information processing apparatus” refers to an information processing system, including at least one processor and a generative AI model, that generates output data such as normalized text or structured information based on input data and control instructions.

The term “prompt sentence” refers to control information, represented as text or an equivalent structured representation, that specifies a task, constraints, or formatting requirements to be applied by a generative AI model when generating output.

The term “prompt generation unit” refers to a functional component implemented by hardware and software that constructs and outputs a prompt sentence based on at least one of current dialog context, user information, and environment information, for use by a generative AI model.

The term “text information” refers to data representing linguistic content in a symbolic format, including strings, tokens, or structured text objects, which are derived from or suitable for natural language processing.

The term “semantic analysis” refers to processing that derives meaning-related information from text information, including at least one of intent classification, slot filling, entity extraction, and relation extraction.

The term “intent extraction unit” refers to a functional component implemented by hardware and software that receives text information and outputs data representing an inferred purpose or requested operation of a user.

The term “natural language processing mechanism” refers to a software and hardware configuration that performs analysis, understanding, and generation of human language, including at least one of tokenization, parsing, semantic interpretation, and response generation.

The term “user intent” refers to information representing a purpose, goal, or requested operation expressed by a user through spoken or written language.

The term “instruction content relating to driving operations” refers to information specifying at least one driving-related action, such as turning, lane changing, stopping, accelerating, or selecting a route, which is derived from user input.

The term “driving instruction information” refers to structured data representing planned travel behavior of a moving body, including at least one of a sequence of maneuvers, target positions, target speeds, and timing constraints.

The term “driving instruction generation unit” refers to a functional component implemented by hardware and software that generates driving instruction information based on user intent, instruction content, and context information.

The term “moving body” refers to a physical object capable of autonomous or semi-autonomous movement, including at least one of a vehicle, a robot, and a mobile platform.

The term “travel route” refers to a path or sequence of positions in a spatial domain that the moving body is intended to follow over time.

The term “travel action” refers to an operation performed by the moving body during movement along the travel route, including at least one of turning, accelerating, decelerating, changing lanes, entering an intersection, and stopping.

The term “travel control quantity” refers to a parameter used to control motion of a moving body, including at least one of target speed, target acceleration, target steering angle, and target position.

The term “surrounding environment information” refers to data describing conditions around a moving body, including at least one of obstacle positions, other traffic participants, road geometry, traffic signals, and weather conditions.

The term “driving control unit” refers to a functional component implemented by hardware and software that calculates travel control quantities and outputs control signals to at least one actuator of a moving body.

The term “drive device” refers to an actuator or subsystem that generates propulsion for a moving body, including at least one of an engine, a motor, and an associated power transmission system.

The term “steering device” refers to an actuator or subsystem that changes a direction of movement of a moving body, including at least one of a steering mechanism, a wheel angle actuator, and associated control hardware.

The term “dynamically generate” refers to creating or modifying data, such as a prompt sentence, at runtime based on current input information, context, or system state, rather than using a fixed, pre-defined value.

The term “structured information” refers to data organized according to a formal schema, such as a key-value structure, a hierarchical object, or a table, which explicitly encodes elements including at least one of intent, conditions, and constraints.

The term “travel priority” refers to a preference condition that affects selection of a travel route or driving behavior, including at least one of minimizing travel time, minimizing distance, maximizing comfort, and optimizing safety margins.

The term “constraint conditions relating to route selection” refers to restrictions or requirements that limit or guide route planning, including at least one of avoiding specific areas, preferring particular road types, and respecting legal or operational limitations.

The term “response information” refers to data used to provide feedback to a user, including at least one of explanations of a travel plan, reasons for specific driving actions, status reports, and warnings.

The term “answer output unit” refers to a functional component implemented by hardware and software that converts response information into an output format suitable for user presentation, including at least one of synthesized speech and visual display.

The term “speech synthesis technology” refers to a method or system that generates artificial speech audio from text or symbolic input, including at least one of concatenative synthesis, parametric synthesis, and neural network-based synthesis.

In one embodiment, a server and a terminal cooperate to implement a system that converts dialect-rich voice commands into standardized spoken language, extracts structured driving intent information, generates driving instruction information, and controls a moving body such as an autonomous vehicle while providing explanatory feedback to a user. The terminal is configured as an in-vehicle computing platform that includes at least one processor, memory, and multiple sound collection devices such as directional microphones installed in the vehicle interior. The terminal includes audio interface hardware compliant with a standard such as a high-definition audio interface, and the terminal executes an operating system such as an embedded Linux distribution. The terminal further includes a sensor interface subsystem that acquires data from cameras, distance sensors, inertial sensors, and position sensors. The terminal is connected to a vehicle control network such as a controller area network to transmit actuation commands and receive feedback signals.

The server is configured as a computing platform that includes at least one high-performance processor, volatile and non-volatile memory, and at least one hardware accelerator such as a graphics processing unit. The server executes an operating system such as a server-grade Linux distribution and runs application software that implements a language conversion unit, an intent extraction unit, a driving instruction generation unit, a driving control unit, a prompt generation unit, and a response generation unit. The server and the terminal are connected by a communication network such as a wireless network and exchange messages through a network protocol such as a secure transport protocol.

The terminal acquires voice information by sampling analog signals from the sound collection devices at a predetermined sampling frequency and quantization resolution, for example, 16 kHz and 16 bits per sample. The terminal applies audio pre-processing by executing a digital signal processing library, which may include a noise suppression module and a beamforming module. The terminal generates digital audio frames with metadata including a timestamp, a device identifier, and a channel identifier, and the terminal transmits the frames to the server over a packet-based network.

The server receives the voice information and performs speech recognition by executing a speech recognition apparatus implemented using a recurrent neural network transducer architecture or a transformer-based speech recognition model. The server converts the voice information into text information representing region-specific spoken language. The server stores the voice information and the text information in a storage system such as a relational database or a key-value store, together with indexing information that enables retrieval for later training or analysis.

The server executes the language conversion unit by using a generative AI model implemented as a transformer-based neural network having multiple layers of self-attention blocks, feed-forward networks, and normalization layers. The generative AI model is trained on pairs of region-specific utterances and standardized utterances so that, during training, the server minimizes a sequence-to-sequence loss function such as a cross-entropy loss between generated token sequences and reference standardized sequences. The server updates the model parameters by applying a gradient-based optimization algorithm such as an adaptive learning rate method. The server optionally performs data augmentation by generating synthetic dialect variants from standardized sentences, thereby increasing robustness to unseen dialect patterns.

The server generates a prompt sentence for the generative AI model by executing the prompt generation unit. The prompt generation unit runs on the same processor as the generative AI model or on a separate processor and constructs the prompt sentence by concatenating fixed instruction phrases with context-specific elements such as a region identifier, a domain identifier, or partial recognition results. The server may use a prompt sentence such as: “Analyze the following transcribed speech, detect dialectal expressions and region-specific traffic terms, and convert them into standardized Japanese driving instructions. Output only the standardized instructions.”

The server appends the region-specific text information to this prompt sentence to form an input sequence to the generative AI model. The generative AI model processes the input sequence token by token, using learned attention weights to focus on relevant parts of the input, and generates an output sequence representing standardized spoken language. The server decodes the output sequence into text information that excludes dialectal and region-specific terms, thereby obtaining standardized spoken language.

The server executes the intent extraction unit by using at least one natural language processing mechanism. In one embodiment, the server uses a classification network based on a transformer encoder that takes the standardized text information as input and outputs an intent label and slot values corresponding to driving-related parameters such as maneuver type, target landmark, and urgency level. In another embodiment, the server calls the same generative AI model with a different prompt sentence that explicitly instructs the generative AI model to output structured information. The server may use a prompt sentence such as: “From the following standardized text, identify the user's driving intent, required maneuvers, and whether the user is in a hurry or prefers comfort. Describe these elements in a concise natural language summary.”

The server parses the output of the generative AI model by applying pattern matching or a lightweight parser to identify tokens that correspond to intent categories, maneuver descriptors, and priority indications. By causing the generative AI model to output information in a constrained format and by post-processing with deterministic parsing rules, the server reduces ambiguity and improves determinism relative to unconstrained language generation.

The server generates driving instruction information by executing the driving instruction generation unit. The server represents the driving instruction information as a data structure that includes a list of waypoints, a sequence of maneuvers, associated speed profiles, and constraint parameters such as minimum time gaps and lateral offset limits. The server computes the waypoints and maneuvers by calling a route planning module that uses a search algorithm such as a heuristic search on a road graph representation. The server combines the route planning results with the extracted intent and constraints to form a driving instruction set that is directly consumable by the driving control unit.

The server executes the driving control unit in one embodiment, and the terminal executes lower-level control loops in another embodiment. The server computes travel control quantities such as target speed and target curvature as a function of the driving instruction information and surrounding environment information. The server may perform this computation by executing a trajectory planner that solves an optimization problem minimizing a cost function that is a weighted sum of trajectory smoothness, safety margin, and consistency with user priorities. The server computes a sequence of reference states, each containing a predicted position, orientation, and speed of the moving body. The server transmits these reference states to the terminal as control targets.

The terminal receives the control targets and compares them with current sensor-derived states. The terminal executes a control algorithm such as a model predictive controller that optimizes actuation commands over a finite prediction horizon to track the control targets while satisfying constraints such as maximum steering rate and maximum acceleration. The terminal computes actuator commands and transmits them to the vehicle control network, thereby controlling the drive device and the steering device. Because the server structures the driving instruction information in a form directly consumable by the control algorithm, the system reduces the number of intermediate transformations, thereby lowering processing latency and decreasing the chance of numerical instability.

The server generates response information by executing a response generation unit that reuses internal data structures of the driving instruction generation unit and the driving control unit. The server constructs a prompt sentence that includes a description of the travel plan and the reasons for particular control decisions, and the server instructs the generative AI model to produce a concise, standardized spoken explanation. The server may use a prompt sentence such as:

“Based on the following driving plan and recent driving actions, explain to the user in simple standardized Japanese what the vehicle will do next and why certain maneuvers, such as slowing down or changing lanes, are necessary. Be concise and polite.”

The server passes structured summaries of the driving instruction information and control results into this prompt, and the server generates a natural language explanation. The terminal converts this explanation into synthetic speech by executing a speech synthesis engine and outputs the speech through speakers, thereby informing the user in real time about the system's behavior.

The system provides technical improvements over conventional arrangements. Because the server uses a transformer-based generative AI model controlled via dynamically generated prompt sentences, the server can adapt the behavior of the language conversion unit and the intent extraction unit to changes in context without retraining the model for each new condition. By constraining the outputs through task-specific prompt sentences and deterministic post-processing, the server reduces the need for complex rule-based pipelines and thereby reduces program complexity and computation overhead. The server also improves recognition and interpretation accuracy for dialect-rich input because the generative AI model is trained with an explicit objective to map dialect expressions to standardized forms in a single sequence-to-sequence transformation, rather than first recognizing dialect and then applying separate, manually designed normalization rules.

The system further improves data management and computation efficiency by representing intermediate results, such as standardized text information and driving instruction information, in formal data structures that are reused by multiple units. For example, the same driving instruction information is used both for generating control targets and for constructing response information. As a result, the server does not need to recompute or duplicate planning logic for user explanations, which reduces processing time and network traffic between server and terminal.

The use of a generative AI model in this system is not a mere automation of human tasks. The generative AI model operates under computational constraints and formatting instructions that humans cannot consistently enforce in real time. The model processes high-dimensional feature representations derived from token embeddings and attention maps and is trained to minimize formal loss functions across large corpora. This leads to behavior that is optimized for latency and reliability in a way that manual procedures cannot match. Furthermore, the integration of the generative AI model with control-oriented data structures and algorithms results in an architecture that is specifically designed to improve the functioning of the computing system as a whole.

In an alternative embodiment, the terminal executes a compact generative AI model locally, and the server executes a larger model in a remote environment. The terminal selects which model to use based on network status, latency requirements, and available computational resources. For example, when network latency is high, the terminal uses the local model and a simplified prompt sentence to perform basic dialect normalization and intent classification, whereas the server performs more complex route planning when the network conditions permit.

In another embodiment, the server uses different prompt generation strategies for different regions or usage scenarios. For instance, the server may include region-specific keywords in the prompt sentence to bias the generative AI model toward particular dialect patterns. In yet another embodiment, the server periodically retrains or fine-tunes the generative AI model with new data collected from operation by using training procedures that include partitioning the data into training and validation sets, computing gradients of the loss function with respect to model parameters, updating the parameters with an optimization method, and validating the updated model for accuracy and robustness before deployment.

By these configurations, the server and the terminal cooperate to provide a technically improved system for handling dialect-rich voice input, generating structured control information, and controlling a moving body in real time. The system reduces error rates in language understanding, reduces control latency, improves the consistency of user feedback with internal control logic, and optimizes computational resources through integrated data structures and prompt-controlled generative AI processing.

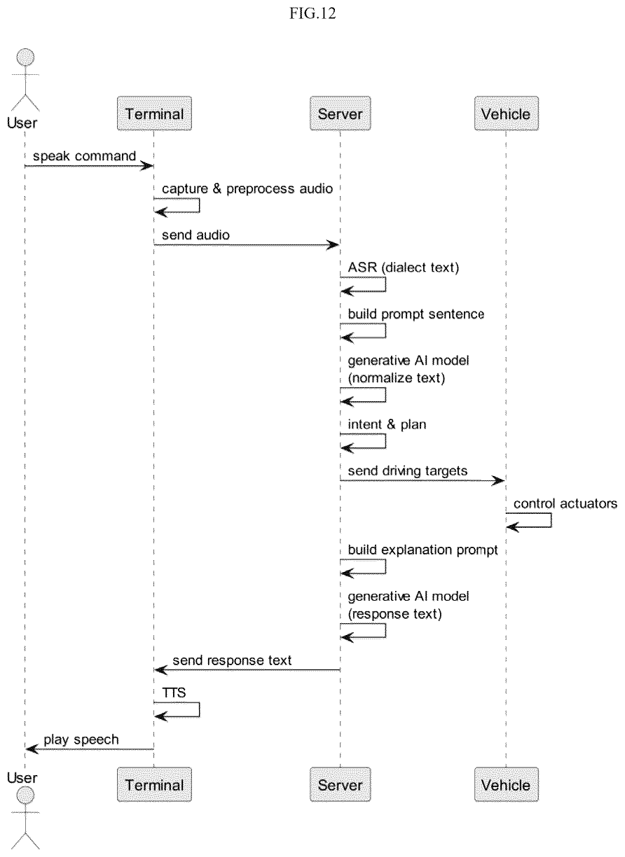

The following describes the processing flow using FIG. 12.

### Step 1:

The user issues a spoken instruction inside the vehicle, such as “Next signal, turn right, then go through the rotary. I am in a hurry today.”

### Step 2:

The terminal acquires the user's voice as an analog audio signal from at least one microphone, and the terminal converts the analog audio into digital voice information (PCM samples) using an audio interface. As input, the terminal receives continuous analog sound pressure variations, and as output, the terminal produces time-stamped digital audio frames. The terminal performs sampling and quantization to map the analog waveform into discrete sample values stored in a buffer.

### Step 3:

The terminal performs audio pre-processing on the digital audio frames by applying noise suppression and beamforming. As input, the terminal uses raw PCM frames contaminated with engine noise and environmental noise, and as output, the terminal generates enhanced PCM frames in which the signal-to-noise ratio of the user's voice is improved. The terminal executes filtering, spectral subtraction, and spatial weighting operations on the sample values to reduce background noise and to emphasize the direction of the user's voice.

### Step 4:

The terminal segments the enhanced audio into utterance units and transmits the utterance units to the server. As input, the terminal uses a stream of enhanced PCM frames and current vehicle/session identifiers, and as output, the terminal produces audio packets that each contain a sequence of contiguous frames plus metadata such as timestamps and identifiers. The terminal applies a voice activity detection algorithm locally or uses fixed-length framing, then encapsulates the frames into network messages and sends them over a secure communication channel.

### Step 5:

The server receives the audio packets from the terminal and reconstructs the utterance-level voice information. As input, the server uses network packets carrying audio frames and metadata, and as output, the server generates continuous utterance segments aligned in time. The server performs packet reassembly, ordering by timestamp, and buffering to ensure that no frames are missing and that the utterances are contiguous.

### Step 6:

The server converts each utterance into region-specific text information by executing a speech recognition process. As input, the server uses the reconstructed utterance audio segments, and as output, the server produces character sequences representing recognized speech, which may contain dialect and region-specific terms. The server performs feature extraction to compute acoustic features such as mel-frequency cepstral coefficients, feeds these features into a trained speech recognition model, and applies a decoding algorithm (for example, beam search) to generate the most likely token sequence.

### Step 7:

The server constructs a prompt sentence for dialect normalization and passes it to a generative AI model together with the region-specific text information. As input, the server uses the recognized dialect-rich text and context data such as region identifiers, and as output, the server produces a composite input string that includes instructions and the raw text. The server concatenates a fixed instruction template, such as “Analyze the following transcribed speech, detect dialectal expressions and region-specific traffic terms, and convert them into standardized Japanese driving instructions. Output only the standardized instructions.” with the recognized text, and the server formats the combined string as a token sequence for the generative AI model.

### Step 8:

The server executes the generative AI model to convert the region-specific text into standardized spoken language. As input, the server uses the tokenized prompt sentence and recognized text, and as output, the server obtains standardized text information in which dialectal and region-specific terms have been replaced by standardized expressions. The server performs embedding lookups for tokens, processes the embeddings through multiple transformer layers with attention and feed-forward computations, and applies a decoding procedure to generate the output token sequence that maximizes the model's conditional likelihood under the instructions given in the prompt sentence.

### Step 9:

The server performs intent extraction and semantic analysis on the standardized text information. As input, the server uses the standardized text and optional context data such as dialog history and user attributes, and as output, the server produces structured intermediate data representing user intent, maneuver types, targets, and priority settings (for example, “hurry” versus “comfort”). The server applies a natural language processing mechanism or an additional call to the generative AI model with a specialized prompt sentence, then parses the resulting text using pattern-based rules or a classifier to map words and phrases into enumerated intent categories and parameter values.

### Step 10:

The server generates driving instruction information from the structured intermediate data. As input, the server uses the extracted intent elements (such as “turn right at next signal” and “pass through roundabout”) and constraint information (such as urgency level), and as output, the server produces a structured driving instruction object that includes a sequence of maneuvers, target positions along a road network, and target speed ranges. The server queries a map database, identifies road segments corresponding to the requested maneuvers, and executes a path search algorithm that computes a route consistent with both the user's intent and traffic rules.

### Step 11:

The server computes high-level trajectory targets for the moving body based on the driving instruction information and surrounding environment information. As input, the server uses the driving instruction object, map topology, and environment data received from the terminal or external services, and as output, the server generates a list of time-stamped reference states including desired positions, orientations, and speeds. The server runs a trajectory planning algorithm that optimizes a cost function combining factors such as path smoothness, collision avoidance, and consistency with user priority, and the server samples the resulting continuous trajectory into discrete reference states.

### Step 12:

The server transmits the driving instruction information and the reference states to the terminal. As input, the server uses the computed reference states and control parameters, and as output, the server produces network messages containing serialized trajectory and maneuver data. The server encodes the data into a predefined message format and sends it through a low-latency communication channel, ensuring that the terminal receives the information in sequential order.

### Step 13:

The terminal receives the trajectory and control targets and aligns them with current sensor data. As input, the terminal uses incoming reference states from the server and locally acquired sensor measurements such as vehicle speed, steering angle, and environment perception data, and as output, the terminal generates error signals representing differences between reference and actual states. The terminal computes these differences by subtracting measured values from target values for each controlled variable.

### Step 14:

The terminal computes actuator commands for the moving body by applying a control algorithm to the error signals. As input, the terminal uses the error signals, control targets, and physical limits of the actuators, and as output, the terminal generates control quantities such as throttle commands, brake pressure levels, and steering angles. The terminal executes an optimization or feedback control loop (for example, a model predictive controller or a proportional-integral-derivative controller) that determines actuator values minimizing tracking error while satisfying constraints, and then encodes these values into messages for the vehicle control network.

### Step 15:

The terminal applies the actuator commands to the drive device and the steering device via a vehicle control interface. As input, the terminal uses the computed control quantities formatted as network commands, and as output, the terminal causes the physical actuators to change torque, braking force, and steering angle. The terminal transmits the commands over a bus such as a controller area network and monitors acknowledgment and feedback signals to confirm that the commands are executed by the actuators.

### Step 16:

The server generates response information that explains the travel plan and recent driving actions to the user. As input, the server uses the driving instruction information, past and current control results, and possibly user preferences, and as output, the server produces explanatory text describing what the vehicle will do and why. The server constructs a prompt sentence addressing the explanatory task, combines it with a summary of planning and control data, feeds this combined text into the generative AI model, and post-processes the generated explanation to ensure it is concise and in standardized language.

### Step 17:

The terminal converts the explanatory text into synthesized speech and outputs it to the user. As input, the terminal uses the response text received from the server, and as output, the terminal produces audio signals that are played through the vehicle speakers. The terminal executes a text-to-speech algorithm to generate audio waveforms from the text, streams the waveforms to the audio output hardware, and thereby informs the user about upcoming maneuvers and reasons for particular control decisions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional dialog systems that process spoken input suffer from several technical limitations when deployed in environments where users speak in regional dialects and exhibit diverse emotional states. First, typical speech recognition pipelines attempt to handle dialectal variation solely within acoustic or language models. This often results in unstable recognition accuracy and inconsistent text output when the input utterances include strong dialects or accents, thereby degrading downstream natural language understanding and response generation. In particular, these systems do not explicitly separate dialectal normalization from recognition, and they do not utilize a generative AI model controlled by structured prompt sentences to robustly convert dialectal text into standardized text. Consequently, the internal textual representation used by subsequent components is noisy and poorly normalized, which increases error propagation and reduces overall system reliability.

Second, traditional emotion recognition components in dialog systems generally rely on either audio signals or text alone, and they are often trained as static classifiers with limited use of contextual information. Such components do not effectively fuse heterogeneous feature data, such as acoustic features, language features, dialog history, and user attributes, into a unified emotional state representation. In addition, existing systems do not exploit a generative AI model, driven by carefully constructed prompt sentences, as an auxiliary inference engine for emotion estimation. As a result, emotion recognition remains inaccurate or unstable, which prevents the system from adaptively controlling response content and prosody in a manner that reflects the user's actual emotional state.

Third, known response generation mechanisms are typically template-based or depend on end-to-end neural models that are not explicitly conditioned on structured emotional states nor on rich dialog context. Such mechanisms do not provide a clear interface, via prompt sentences, between structured internal state (standardized text, intent, slots, emotion state, user profile, dialog history) and a generative AI model. Therefore, these systems are unable to systematically adjust the generated response text and synthesized speech parameters according to fine-grained emotional categories and their intensities. In particular, conventional systems do not include post-generation control logic that can, based on an estimated emotional state, rewrite responses via additional prompt sentences so as to enhance empathy and reassurance.

From a computer-technology standpoint, there is a need for an improved dialog processing architecture that decomposes the processing pipeline into explicit functional units executed by a processor, and that uses a generative AI model in a controlled manner through prompt sentences at multiple stages. Such an architecture should (i) normalize dialectal speech into stable standard text representations, (ii) compute and integrate multi-modal emotion features with auxiliary generative AI-based estimation, and (iii) generate and refine responses and speech synthesis parameters according to structured emotional states. Without such improvements, dialog systems cannot reliably manage dialectal variability, cannot robustly infer emotional conditions, and cannot algorithmically control response content and prosody, leading to degraded usability and inconsistent system behavior.

The specific processing by the specific processing unit 290 of the data processing device 12 in Example 2 is realized by the following means.

The present invention provides a server comprising a processor configured to acquire audio data representing a user utterance via an audio input device under predetermined sampling conditions, to perform acoustic processing and speech recognition processing on the audio data so as to generate character string data including a dialect expression, to generate a first prompt sentence describing conditions for converting the character string data into a standard language, to input the character string data and the first prompt sentence to a generative AI model so as to generate standard language text, to calculate acoustic feature data from the audio data and language feature data from the standard language text, to estimate an emotional state of the user based at least on the acoustic feature data and the language feature data, to generate a second prompt sentence describing content of the user utterance and the emotional state together with dialog history information and attribute information, to input the second prompt sentence to the generative AI model so as to generate response text, to control content or expression of the response text according to the emotional state, and to determine speech synthesis parameter data based on the response text and the emotional state so as to generate and output synthesized speech. This enables a computer-implemented dialog system to normalize dialectal utterances into stable standard language text via prompt-controlled generative AI inference, to compute and refine a structured emotional state by fusing multi-modal feature data and auxiliary generative AI outputs, and to algorithmically control both response text and speech prosody according to the emotional state, thereby improving robustness, adaptability, and overall technical performance of dialog processing.

The term “audio input device” refers to a hardware unit or a combination of hardware and software configured to capture sound waves from an environment and convert the sound waves into digital audio data under predetermined sampling conditions.

The term “audio data” refers to digital information representing an audio signal, including a sequence of sampled values obtained from an audio input device according to a predetermined sampling rate, bit depth, and channel configuration.

The term “acoustic processing” refers to a sequence of operations applied to audio data, including at least one of noise reduction, echo cancellation, gain control, filtering, framing, and windowing, in order to improve signal quality or extract acoustic information for further processing.

The term “speech recognition processing” refers to computational operations that convert audio data representing spoken language into character string data by using an acoustic model and a language model executed by a processor.

The term “character string data including a dialect expression” refers to textual data output by speech recognition processing that contains words, phrases, or constructions characteristic of a regional dialect or accent rather than a standardized language form.

The term “standard language text” refers to textual data in which dialect expressions or non-standard forms are converted into a standardized language form according to predetermined grammatical and lexical rules.

The term “prompt sentence” refers to a text-based instruction sequence provided as input to a generative AI model, the instruction sequence describing at least one of processing conditions, conversion conditions, output format, role constraints, or content constraints to control the behavior of the generative AI model.

The term “generative AI model” refers to a machine-learning model, including at least a neural network trained on large-scale data, that generates new text or other data based on one or more input sequences, including a prompt sentence and optional auxiliary inputs.

The term “dialect recognition unit” refers to a functional unit implemented by a processor and memory that is configured to receive character string data including a dialect expression and a prompt sentence, to input the data to a generative AI model, and to output standard language text obtained from the generative AI model.

The term “acoustic feature data” refers to numerical data derived from audio data, including at least one of fundamental frequency, energy, spectral characteristic, speech rate, and silence duration, represented as scalar values, vectors, or matrices for use in subsequent analysis.

The term “language feature data” refers to numerical or symbolic data derived from text, including at least one of emotion expressions, negation expressions, emphasis expressions, lexical patterns, and syntactic patterns, encoded for use in computational processing.

The term “emotional state” refers to an internal representation of a user's affective condition, including at least one emotion category and a corresponding intensity value, derived from acoustic feature data, language feature data, and optional contextual data.

The term “emotion recognition unit” refers to a functional unit implemented by a processor and memory that is configured to receive acoustic feature data and language feature data, to optionally receive contextual information, and to estimate an emotional state of a user by applying one or more computational models.

The term “dialog history information” refers to stored data representing at least part of past interaction between a user and a system, including previous user utterances, system responses, estimated emotional states, timestamps, and optional contextual attributes.

The term “attribute information” refers to data describing properties of a user, including at least one of age, gender, health condition, usage history, and environment, which is used as contextual information in dialog processing.

The term “additional information” refers to information other than a current user utterance, including at least dialog history information and attribute information, that is used to condition processing by the generative AI model or other computational components.

The term “response text” refers to textual data generated by a system, including at least one sentence intended to be presented to a user as a response to a user utterance.

The term “response generation unit” refers to a functional unit implemented by a processor and memory that is configured to generate prompt sentences including at least a standard language text and an emotional state, to input the prompt sentences to a generative AI model to obtain response text, and to control content or expression of the response text according to the emotional state.

The term “expression control” refers to a modification process applied to response text, including at least insertion, deletion, or rewriting of words or phrases, in order to adjust tone, politeness, or empathy level according to an emotional state.

The term “speech synthesis parameter data” refers to control values used by a speech synthesis engine, including at least a speaking rate, a pitch, and a prosody level, that influence temporal and acoustic characteristics of synthesized speech.

The term “speech synthesis processing” refers to computational operations that convert response text and speech synthesis parameter data into audio data representing synthesized speech by using a text-to-speech engine.

The term “synthesized speech” refers to audio data generated by speech synthesis processing that represents an audible utterance of response text according to given speech synthesis parameter data.

The term “audio output unit” refers to a functional unit including at least a speech synthesis engine and an audio playback interface, the functional unit being configured to receive response text and speech synthesis parameter data, generate synthesized speech, and output the synthesized speech through an audio output device.

The term “output device” refers to a hardware unit configured to present synthesized speech to a user, including at least one of a loudspeaker, a headphone, or an earphone driven by an audio playback circuit.

The term “machine learning model included in the emotion recognition unit” refers to a computational model, such as a neural network or statistical classifier, trained on labeled data to map input feature data to one or more emotion categories with associated intensity values.

The term “emotion score data” refers to numerical values output by a generative AI model or a machine learning model, the numerical values representing predicted intensities or probabilities for a plurality of emotion categories.

The term “expression adjustment rule” refers to a predefined rule or a set of rules that associates at least one emotion category and an intensity range with specific modifications to response text, such as addition of reassurance phrases or softening of directive expressions.

The term “natural language understanding processing” refers to computational operations that analyze text in order to extract structured information, including at least user intention, important information, semantic roles, or slot values, from the text.

The term “intention of the user” refers to a classification label or structured representation indicating a purpose or goal underlying a user utterance, such as a request, a question, or a consultation.

The term “important information” refers to structured data extracted from a user utterance, including at least one key topic, entity, or parameter relevant to the user's intention.

In one embodiment, a server, a terminal, and a user cooperate to implement a dialog support system that performs dialect normalization, emotion recognition, and emotion-aware response generation using a generative AI model controlled by prompt sentences. The server is implemented as a general-purpose information processing apparatus including at least one processor, a memory, a non-volatile storage device, and a network interface. The terminal is implemented as an information terminal including a microphone, a loudspeaker, at least one processor, a memory, and a wireless communication interface. The user is, for example, a resident of a care or welfare facility who speaks to the terminal in a regional dialect.

The terminal executes an operating system such as a mobile operating system and a dialog application program. The terminal acquires an analog voice signal of the user via a built-in microphone or an array microphone and uses an audio input API (for example, an audio recording API provided by the operating system) to convert the analog signal to digital audio data with a predetermined sampling rate (for example, 16 kHz) and bit depth (for example, 16-bit). The terminal applies a software-based signal processing library, such as a library implementing noise suppression, echo cancellation, and automatic gain control (for example, a module based on the WebRTC audio processing library or an embedded digital signal processing library), to the audio data to reduce environmental noise and to stabilize amplitude.

The terminal then compresses the processed audio data using an audio codec such as Opus or Advanced Audio Coding and transmits the compressed audio data to the server over a packet network using a communication protocol stack (for example, a transmission control protocol over a wireless local area network).

The server receives the compressed audio data via the network interface and reconstructs a continuous audio stream associated with a session identifier or user identifier. The server uses an audio decoder corresponding to the codec used by the terminal to restore linear pulse-code modulation audio data in a standard format (for example, 16 kHz, 16-bit, monaural). The server stores this audio data in the memory in a buffer structure. The server optionally applies additional acoustic preprocessing such as level normalization or band-pass filtering and detects speech segments by executing a voice activity detection algorithm, for example, an algorithm based on energy thresholds or a statistical model such as a Gaussian mixture model.

The server associates each detected speech segment with metadata including a timestamp and a user identifier.

The server executes speech recognition processing on each speech segment by invoking a speech recognition engine such as a neural-network-based recognizer (for example, an engine implemented using a recurrent neural network or a Transformer-based encoder-decoder model in a framework such as TensorFlow or PyTorch). The server uses an acoustic model that maps sequences of acoustic feature vectors (for example, Mel-frequency cepstral coefficients or filterbank features computed via framing and fast Fourier transform) to phoneme or sub word probabilities, and a language model that estimates probabilities of word sequences. The server computes posterior probabilities using, for example, a connectionist temporal classification objective or an attention-based decoding procedure and decodes the most likely character or word sequence, thereby generating character string data including dialect expressions. The server stores the recognized text, which may contain regional lexicon and dialectal grammar, in a dialog context record along with references to the corresponding audio segment.

The server performs dialect normalization by using a generative AI model controlled through a prompt sentence. The server constructs a prompt sentence in natural language that specifies conversion conditions, including that the recognized dialectal text should be transformed into polite standard language suitable for use in a care facility. The server concatenates a fixed instruction template and the recognized dialect text to form an input sequence. An example of the prompt sentence generated by the server is:

“The following text is the result of speech recognition of Japanese utterances that include dialect expressions. Please convert this text into polite, standard Japanese suitable for use in a nursing care facility. In particular, please replace dialect expressions from the Kansai and Tohoku regions with natural standard Japanese.

Dialect text: “Lately, I haven't been sleeping very well.”

The server inputs this prompt sentence to the generative AI model. The generative AI model is implemented as a large-scale neural network, for example, a Transformer-based language model that includes a stack of multi-head self-attention layers and feed-forward layers trained on a large corpus of text. The server may host this model locally or access an external model service via an application programming interface. The server encodes the prompt sentence into tokens, feeds the tokens through the network, and obtains a probability distribution over output tokens at each step. The server decodes the highest-probability sequence or samples from the distribution under configured decoding parameters (for example, temperature or top-k sampling) to obtain standard language text such as “Recently, I haven't been sleeping very well.”. The server stores the resulting standard language text in the dialog context as a normalized representation of the user's utterance.

The server then executes emotion recognition by combining acoustic feature data and language feature data. The server computes acoustic feature data by applying an acoustic analysis module implemented using, for example, a numerical library such as librosa or a custom digital signal processing module. The server performs framing and windowing on the audio segment, computes a fast Fourier transform for each frame, and derives features such as fundamental frequency, energy, spectral centroid, spectral tilt, Mel-frequency cepstral coefficients, speaking rate, and silence durations. The server arranges these values into a two-dimensional array indexed by time frame and feature dimension. The server normalizes the feature values by subtracting means and dividing by standard deviations to improve numerical stability during learning-based inference.

The server extracts language feature data from the standard language text by using a morphological analyzer such as a Japanese part-of-speech tagger and an emotion lexicon storing lists of emotion-related terms, negations, and intensifiers. The server segments the text into tokens, assigns part-of-speech tags, identifies emotion expressions (for example, words corresponding to “lonely”, “anxious”, “happy”, “tired”), and recognizes polarity modifiers such as negation terms and emphasis markers. The server encodes the presence, count, and syntactic position of these tokens into feature vectors and may also compute distributed representations such as sentence embeddings using a pre-trained language representation model. The server stores the acoustic and language feature data as structured feature objects in memory.

The server estimates an emotional state by inputting the acoustic and language feature data into an emotion recognition neural network. In one example, the emotion recognition neural network is a multi-modal network including an acoustic branch and a text branch. The acoustic branch includes a sequence of recurrent layers, such as gated recurrent units or long short-term memory layers, that process the time sequence of acoustic feature vectors and output an acoustic embedding. The text branch includes a sequence of layers such as a Transformer encoder or a bidirectional recurrent layer that processes token embeddings and outputs a language embedding. The server concatenates these embeddings, optionally together with a vector representing dialog history and user attributes (for example, age and health condition), and feeds the concatenated vector into a fully connected layer to produce emotion scores for predefined categories (for example, joy, anger, sadness, anxiety, relief, fatigue).

The server trains this model offline using supervised learning. During training, the server uses a labeled dataset of audio and text pairs with associated emotion labels, defines a loss function such as cross-entropy or mean squared error for intensity values, and updates model weights via gradient-based optimization (for example, stochastic gradient descent or adaptive moment estimation). The server may use data augmentation methods such as time stretching and noise addition for audio and synonym replacement for text to improve generalization.

At run time, the server outputs a vector of emotion scores and normalizes the scores into intensities between zero and one. The server identifies a primary emotion category based on the maximum intensity or a rule-based threshold. The server stores this emotional state in the dialog history information associated with the current turn.

The server optionally refines the emotional state using the generative AI model as an auxiliary inference component. The server constructs a prompt sentence that describes, in natural language, the standard language text, the summarized acoustic characteristics, recent dialog trend, and the user profile. An example prompt sentence for emotion estimation is:

“Based on the following information, please estimate the current emotional state of the speaker.

Text: “Recently, I haven't been sleeping very well.”

Voice characteristics (summary): The voice is somewhat quiet, the speaking rate is slow, and there are sigh-like sounds.

Recent conversation trend: In conversations over the past several days, concerns about physical condition and sleep have been expressed multiple times.

User profile: A woman in her 80s with mild cognitive impairment.

Emotion categories are ‘joy’, ‘anger’, ‘sadness’, ‘anxiety’, ‘relief’, and ‘fatigue’. For each category, output an intensity value between 0 and 1.”

The server inputs this prompt sentence to the generative AI model and receives a text output containing numerical values for each emotion category. The server parses the output to extract the scores and converts them to floating-point values. The server then combines these scores with the scores output by the dedicated emotion recognition neural network using a defined fusion algorithm, such as a weighted average where weights are determined experimentally or depend on confidence measures. This combined estimation provides increased robustness in cases where one modality (audio or text) is noisy. By explicitly using prompt sentences to condition the generative AI model, the server guides the model to produce structured and machine-readable emotion scores, which enhances computational efficiency and reduces parsing errors compared to unstructured free-form responses.

The server performs response generation by using both the standard language text and the emotional state. The server first performs natural language understanding on the standard language text to extract the user's intention and important information. The server uses, for example, a classifier to map the text to an intent label such as “health consultation” and a sequence-labeling model to identify slots such as “sleep” as the topic. These models may be implemented as neural networks based on pre-trained language representations. The server stores the intent and slot information in a structured data record.

The server constructs a prompt sentence for response generation by embedding the standard language text, the intent, the important information, the emotional state, the user profile, the dialog history information, and optional external information (for example, weather status or facility events) into a natural language template. An example of such a prompt sentence is: “You are a Japanese conversational support AI that talks with residents in an elderly care facility. Based on the following information, please generate one response sentence that is polite, friendly, and sensitive to the user's emotions.

User's utterance (standard Japanese): “Recently, I haven't been sleeping very well.”

User's intent: consultation about physical condition

Important information: concern about sleep

User's emotional state: the main emotion is ‘anxiety’ with intensity 0.8.

User profile: a woman in her 80s who recently entered the facility.

Past conversations: in the past few days, she has mentioned anxiety about sleep several times.

Facility information: tonight the temperature is expected to drop, and you would like to encourage adjustment of the bedroom temperature.

Prioritize expressions that alleviate the user's ‘anxiety’ and provide a sense of reassurance and empathy.”

The server inputs this prompt sentence to the generative AI model. Because the prompt sentence explicitly encodes structured state information and constraints, the generative AI model generates a response text that is aligned with the user's emotional condition and context, while the server remains in control of the input information and the role description. The server receives the generated response text, stores it as base response text, and applies additional rule-based or learned post-processing to adjust expressions. For example, when the emotional state indicates high anxiety, the server examines the response text to check whether reassurance phrases such as “it is okay”, “let us think together”, or “we will help you rest comfortably” are included. If necessary, the server enriches the response by constructing another prompt sentence to rewrite the base response:

“Rewrite the following response so that it acknowledges the user's ‘anxiety’ more gently and expresses reassurance and empathy more strongly.

Original response:” So, you haven't been sleeping well lately. That must be worrying for you. Since it may get a bit cooler tonight, shall we take a look together at the room temperature and how your bedding is set? If needed, we can also talk with a nursing staff member.”

The server inputs this prompt sentence to the generative AI model and obtains a rewritten response text with more empathetic expressions. In this manner, the server uses a non-conventional two-stage generation and rewrite process controlled by explicit prompt sentences and emotion-dependent rules, which provides finer control over the content and style than conventional single-stage generative systems.

The server determines speech synthesis parameter data based on the final response text and the emotional state. For example, when the emotional state is anxiety with a high intensity, the server sets the speaking rate parameter to a value slightly slower than a default value, the pitch parameter to a slightly lower value, and the prosody parameter to provide smoother, less abrupt intonation transitions. These parameters are represented as numerical values or control codes that a text-to-speech engine can interpret. The server includes the response text and the speech synthesis parameters in a response message and transmits the message to the terminal. The terminal receives the response message, parses the content, and invokes a speech synthesis engine, such as a text-to-speech engine provided by the operating system or a neural text-to-speech module based on architectures such as sequence-to-sequence models with attention or feed-forward models. The terminal supplies the response text and speech synthesis parameters to the engine, which converts the text into phonetic and prosodic representations and synthesizes a waveform accordingly. The terminal outputs the synthesized speech through the loudspeaker. The user hears a response whose content and acoustic characteristics are automatically adjusted according to the user's emotional state, which a human operator could not consistently produce at scale, and which is generated using technical control of audio acquisition, feature computation, neural inference, and speech synthesis parameters.

This architecture provides technical effects beyond mere automation of human dialog. By explicitly decomposing the processing into modules for acoustic feature computation, language feature computation, multi-modal emotion recognition, prompt-controlled generative text conversion, and emotion-conditioned speech synthesis, the server achieves improved recognition accuracy for dialectal speech, reduced error propagation, and more stable internal text representations. The dialect normalization step reduces variance in linguistic input to downstream modules, which improves computational efficiency and reduces model size requirements for downstream components. The multi-modal fusion of acoustic and language features, combined with auxiliary generative AI inference, yields higher emotion recognition accuracy than methods using only a single modality, which in turn allows more precise control of response generation and prosody. The use of structured prompt sentences at multiple stages converts unstructured natural language instructions into a reproducible interface between internal data structures and the generative AI model, improving determinism and enabling optimization of prompt layouts for latency and bandwidth (for example, by omitting redundant context fields).

The server can implement variations of this embodiment. For example, the dialect recognition unit may be replaced or supplemented by a dedicated sequence-to-sequence neural network trained to map dialect text directly to standard language text without an external generative model, while still using prompt sentences to control specific style or politeness levels. The emotion recognition unit may use different neural architectures such as convolutional neural networks for acoustic processing or graph-based networks for dialog history modeling. The generative AI model may be hosted locally on the server for low-latency operation or may be accessed remotely when computation resources are limited. The terminal may execute part of the feature extraction or emotion recognition logic to reduce server load. In all variations, the server, terminal, and user cooperate through the described data flows, and the system uses prompt sentences to control a generative AI model and to manage dialectal variation and emotional state in a technically constrained and improved manner.

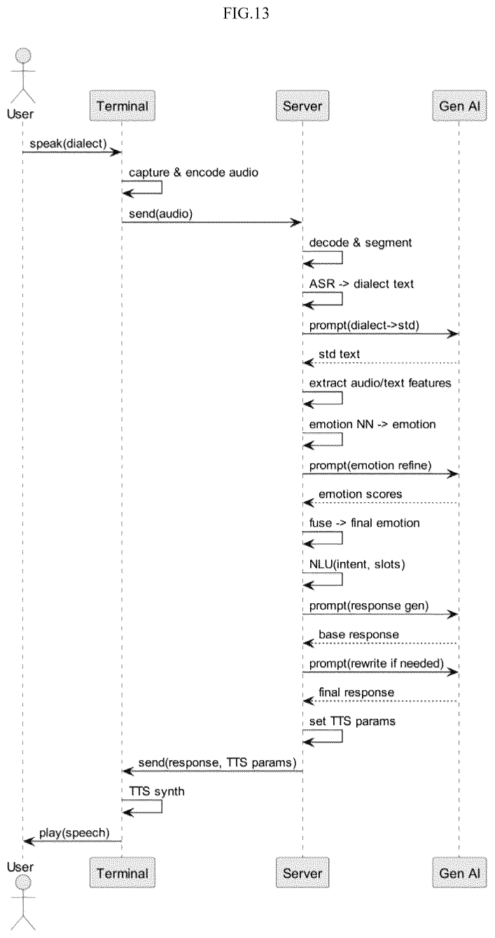

The following describes the processing flow using FIG. 13.

### Step 1:

The user provides a spoken utterance as input by speaking toward the terminal in a natural manner, optionally using a regional dialect or accent, and the user may talk about topics such as physical condition, daily life, or concerns. The output of this step is an analog voice signal in the air generated by the user's vocal cords and articulatory movements.

### Step 2:

The terminal receives the analog voice signal as input via a built-in microphone or an external array microphone, and the terminal uses an audio input application programming interface of the operating system to sample the signal at a predetermined sampling rate and bit depth (for example, 16 kHz, 16-bit), thereby performing analog-to-digital conversion. The terminal applies signal-processing operations such as noise suppression, echo cancellation, and automatic gain control using a signal-processing library and outputs cleaned digital audio data as a sequence of audio frames.

### Step 3:

The terminal takes the cleaned digital audio data as input and compresses the data by executing an audio codec algorithm, for example, a codec based on a transform or linear prediction method. The terminal packages the compressed audio frames together with metadata including at least a session identifier, a user identifier, and timestamp information into network packets. The terminal then transmits the packets to the server via a network protocol stack, and the output of this step is a stream of compressed audio packets on a network.

### Step 4:

The server receives the compressed audio packets as input through a network interface and reconstructs an ordered stream of compressed audio frames by reassembling packets based on sequence numbers and metadata. The server decodes the compressed frames using a corresponding audio decoder so as to restore linear pulse-code modulation audio data in a standard format. The server may apply additional acoustic preprocessing such as level normalization and band-pass filtering, and the server executes a voice activity detection algorithm on the audio data to segment the continuous stream into utterance-level audio segments. The output of this step is one or more audio segments, each associated with a user identifier and a time interval.

### Step 5:

The server takes an audio segment as input and performs speech recognition processing by computing acoustic features such as Mel-frequency cepstral coefficients or filterbank energies through framing and fast Fourier transforms. The server feeds these feature sequences to a speech recognition engine that includes an acoustic model and a language model, for example, a neural model based on recurrent layers or Transformer layers, and decodes the most probable character or word sequence using a decoding algorithm such as beam search. The server outputs character string data representing the recognized utterance, which may include dialect expressions, and stores the mapping between the audio segment and the recognized text.

### Step 6:

The server uses the recognized character string data including dialect expressions as input and constructs a prompt sentence for dialect normalization by concatenating a fixed instruction template and the recognized text. The server generates a prompt sentence such as: “The following text is the result of speech recognition of Japanese utterances that include dialect expressions. Please convert this text into polite, standard Japanese suitable for use in a nursing care facility. In particular, please replace dialect expressions from the Kansai and Tohoku regions with natural standard Japanese.

Dialect text: “Lately, I haven't been sleeping very well.”

The server tokenizes the prompt sentence and provides the tokens to a generative AI model implemented as a large-scale Transformer-based language model. The server executes a forward pass of the model to compute output token probabilities and decodes the output to obtain a standardized text sequence. The output of this step is standard language text, such as “Recently, I haven't been sleeping very well.”, stored in the dialog context.

### Step 7:

The server takes the audio segment as input and computes acoustic feature data by applying an acoustic analysis library. The server performs operations including framing, windowing, and fast Fourier transform, and derives features such as fundamental frequency, frame energy, spectral centroid, Mel-frequency cepstral coefficients, speaking rate, and durations of silence. The server normalizes the feature values and arranges them into a two-dimensional feature matrix indexed by time and feature dimension. The output of this step is acoustic feature data suitable for input to machine-learning models.

### Step 8:

The server takes the standard language text as input and performs language analysis using a morphological analyzer and an emotion lexicon. The server segments the text into tokens, assigns part-of-speech tags, and identifies emotion expressions, negation expressions, and emphasis expressions by matching tokens against entries in the lexicon. The server encodes counts, presence flags, and positional patterns of these tokens into numerical vectors, and may also compute sentence-level embeddings using a pre-trained text encoder. The output of this step is language feature data representing the emotional and structural characteristics of the text.

### Step 9:

The server receives the acoustic feature data and the language feature data as inputs and feeds them into an emotion recognition neural network, for example, a multi-modal network with separate acoustic and text branches. The server computes an acoustic embedding from the acoustic data using recurrent or convolutional layers, computes a text embedding from the language data using a sequence model or encoder, and concatenates these embeddings along with optional vectors representing dialog history and user attributes. The server propagates this concatenated vector through one or more fully connected layers and applies an activation function to obtain emotion score values for each predefined emotion category. The server normalizes the scores into intensities between zero and one and determines an emotional state that includes at least a main emotion category and an intensity. The output of this step is an emotional state vector stored in dialog history.

### Step 10:

The server optionally uses the standard language text, summarized acoustic characteristics, dialog history information, and attribute information as input to build a prompt sentence for auxiliary emotion estimation. The server composes a natural-language description such as: “Based on the following information, please estimate the current emotional state of the speaker.

Text: “Recently, I haven't been sleeping very well.”

Voice characteristics (summary): The voice is somewhat quiet, the speaking rate is slow, and there are sigh-like sounds.

Recent conversation trend: In conversations over the past several days, concerns about physical condition and sleep have been expressed multiple times.

User profile: A woman in her 80s with mild cognitive impairment.

Emotion categories are ‘joy’, ‘anger’, ‘sadness’, ‘anxiety’, ‘relief’, and ‘fatigue’. For each category, output an intensity value between 0 and 1.”

The server inputs this prompt sentence to the generative AI model, obtains a text output containing numerical values for each emotion category, parses and converts the values to numeric emotion score data, and fuses these scores with the scores from the emotion recognition neural network using a predefined combination rule, such as weighted averaging. The output of this step is a refined emotional state vector used as the final emotional state.

### Step 11:

The server takes the standard language text and the final emotional state as inputs and performs natural language understanding processing to extract the user's intention and important information. The server applies a trained classifier to the text to determine an intent label, for example, “health consultation”, and uses a sequence-labeling model to detect slot values such as “sleep” as the main topic. The server writes the intent and slot data into a structured record linked with the current dialog turn. The output of this step is structured intent and important information for use in response generation.

### Step 12:

The server receives the standard language text, the intent, the important information, the final emotional state, the dialog history information, and the attribute information as inputs and constructs a response-generation prompt sentence by embedding these data values into a natural-language template. The server may generate a prompt sentence such as: “You are a Japanese conversational support AI that talks with residents in an elderly care facility. Based on the following information, please generate one response sentence that is polite, friendly, and sensitive to the user's emotions.

User's utterance (standard Japanese): “Recently, I haven't been sleeping very well.”

User's intent: consultation about physical condition

Important information: concern about sleep

User's emotional state: the main emotion is ‘anxiety’ with intensity 0.8.

User profile: a woman in her 80s who recently entered the facility.

Past conversations: in the past few days, she has mentioned anxiety about sleep several times.

Facility information: tonight the temperature is expected to drop, and you would like to encourage adjustment of the bedroom temperature.

Prioritize expressions that alleviate the user's ‘anxiety’ and provide a sense of reassurance and empathy.”

The server tokenizes the prompt sentence and inputs the tokens to the generative AI model, then decodes the output token sequence to obtain a base response text in standard language. The output of this step is the base response text stored in the dialog context.

### Step 13:

The server takes the base response text and the final emotional state as inputs and performs emotion-based expression control. The server checks, using string search or pattern-matching rules, whether the base response includes phrases aligned with the emotional category and intensity, such as explicit reassurance phrases for high anxiety. If the base response is judged insufficient according to predefined expression adjustment rules, the server constructs a rewrite prompt sentence such as:

“Rewrite the following response so that it acknowledges the user's ‘anxiety’ more gently and expresses reassurance and empathy more strongly.

Original response:” So, you haven't been sleeping well lately. That must be worrying for you. Since it may get a bit cooler tonight, shall we take a look together at the room temperature and how your bedding is set? If needed, we can also talk with a nursing staff member.”

The server inputs this rewrite prompt sentence and the original response to the generative AI model, obtains a rewritten response text, and selects this text as the final response text. The output of this step is final response text that has been adjusted according to emotion-dependent rules.

### Step 14:

The server uses the final response text and the final emotional state as inputs and calculates speech synthesis parameter data. The server maps emotion categories and intensities to numerical parameter values, such as a speaking rate multiplier, a target pitch offset, and a prosody pattern index, using an emotion-to-parameter mapping table or a learned regression model. The server encapsulates the final response text and the computed speech synthesis parameter data in a response message formatted for the terminal. The output of this step is a response message ready for transmission.

### Step 15:

The server transmits the response message as input to the terminal over the network, and the terminal receives and parses the message to extract the response text and the speech synthesis parameter data. The terminal then invokes a speech synthesis engine with these inputs, performing text analysis, phonetic conversion, and waveform generation according to the specified parameters, and outputs synthesized speech through the loudspeaker. The user perceives the synthesized speech as output, and the acoustic characteristics, including rate, pitch, and prosody, are tuned to reflect the user's emotional state derived from the previous processing steps.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional voice-based human-machine interfaces that handle non-standard language, such as regional dialects or colloquial expressions, typically rely on a monolithic speech-recognition or natural-language-processing pipeline. Such systems often embed dialect normalization, intent understanding, and response generation into a single statistical or neural model. As a result, these systems have several technical limitations from a computer-technology perspective.

First, conventional architectures generally treat dialect handling as a static mapping problem inside an acoustic or language model. When a user speaks with region-specific vocabulary, prosody, or traffic-related expressions, the recognition engine frequently mis-recognizes the content, or produces ambiguous text that is difficult for downstream modules to interpret. Updating or re-training such models for every dialect or domain incurs significant computational cost and system complexity and requires frequent re-deployment of models. Consequently, the overall system lacks robustness and scalability across diverse linguistic variations.

Second, many existing systems fail to exploit multimodal information and structured prompt control for emotion-aware processing. Emotional state estimation, if present at all, is typically implemented as a separate classifier using either audio or image features only, and is loosely coupled or completely decoupled from the natural-language understanding pipeline. Downstream modules often ignore this information when generating system actions or explanations. This separation causes inefficient use of available computational resources and sensor data, and prevents the system from optimizing its behavior (e.g., vehicle control policies) according to the user's real-time emotional state.

Third, in the context of automated vehicle control, conventional systems do not provide a robust mechanism for tightly integrating dialect normalization, multimodal emotion recognition, and context-aware driving-instruction generation into a unified, prompt-driven generative-AI workflow. Typically, the driving-policy generation module is manually programmed or rule-based, consuming only a simplified textual command and limited environment data. Such architectures do not leverage advanced generative models with explicit natural-language prompt sentences that describe processing conditions, constraints, and structured output formats. As a result, the system cannot easily adapt driving parameters, such as speed limits, acceleration bounds, or maneuver sequences, in response to nuanced user instructions and emotional cues, and cannot dynamically produce user-facing explanations aligned with the actual control decisions.

Fourth, from a system-engineering viewpoint, conventional designs often blur the division of labor between an in-vehicle terminal and a remote server, leading either to an overburdened terminal with heavy machine-learning workloads or to a server that receives raw, unprocessed sensor streams and must perform all low-level processing. Both extremes degrade computational efficiency, increase network bandwidth usage, and complicate real-time guarantees. There is a need for a computer-implemented architecture that clearly separates and optimizes terminal-side preprocessing (such as noise reduction, beamforming, and feature extraction) from server-side generative reasoning, thereby improving overall system throughput, latency, and resource utilization.

Accordingly, there is a need for improved computer technology that: (i) modularizes dialect normalization, multimodal emotion recognition, and driving-instruction generation into distinct but coordinated server-side functions controlled by explicit natural-language prompt sentences; (ii) utilizes generative AI models as configurable inference engines whose behavior is governed by dynamically generated prompts rather than hard-coded logic; and (iii) coordinates terminal-side sensor preprocessing and server-side generative processing in a way that enhances robustness, scalability, and real-time performance of automated vehicle control and user interaction.

The specific processing by the specific processing unit 290 of the data processing device 12 in Application Example 2 is realized by the following means.

The present invention provides a server comprising a processor configured to receive, via a communication interface, preprocessed audio data, acoustic-feature time-series data, image data for emotion estimation, and associated metadata from a terminal, the terminal having performed noise reduction, directivity control, acoustic-feature extraction, face-region detection, and image compression using local computational resources; to execute, as a server-side speech-recognition function, a speech-recognition machine-learning model on the audio data to generate character-string data representing an utterance of a user; to execute, as a dialect conversion function, a generative AI model by dynamically generating and supplying a natural-language prompt sentence that defines processing content and output format for converting dialect expressions and region-specific expressions contained in the character-string data into standardized-language text, and by obtaining, from the generative AI model, normalized standardized-language text; to execute, as an emotion recognition function, a generative AI model or an emotion-classification machine-learning model by dynamically generating and supplying a natural-language prompt sentence that specifies requirement items and structured output for estimating an emotional state of the user based on the standardized-language text, the acoustic-feature time-series data, the image data for emotion estimation, and dialogue-history information, and by obtaining emotion-state data including an emotion category, an emotion intensity, and an urgency index; to execute, as a driving-instruction generation function, a generative AI model by dynamically generating and supplying a natural-language prompt sentence that defines conditions, constraints, and output items for generating a driving action sequence, a speed policy, a route policy, and an explanation text for the user based on the standardized-language text, the emotion-state data, and surrounding-environment information acquired from an external information source, and by obtaining driving-instruction information and explanation-text data; and to execute, as a control-command generation function, processing that converts the driving-instruction information into control-command data in a format interpretable by an electronic control apparatus for vehicle control and transmits the control-command data and the explanation-text data to the terminal via the communication interface. This enables a modular, prompt-driven server architecture in which dialect normalization, multimodal emotion recognition, and driving-instruction generation are performed by generative AI models under explicit natural-language prompt control, thereby improving robustness to dialectal variation, enhancing use of multimodal sensor data, and optimizing automated vehicle control and user guidance in real time while efficiently distributing computational workloads between the terminal and the server.

The term “acoustic detection device” refers to a sensing apparatus configured to detect sound waves in an environment, convert the sound waves into electrical signals, and output audio signals representing utterances of a user.

The term “audio signal” refers to an analog or digital signal that represents temporal variations in air pressure corresponding to sound, including spoken utterances of a user.

The term “sampling frequency” refers to a numerical parameter indicating how many samples of an analog audio signal are taken per unit time to convert the analog signal into a digital representation.

The term “bit depth” refers to a numerical parameter indicating the number of bits used to represent the amplitude of each sample in a digitized audio signal.

The term “frame-sequence audio data” refers to a digital representation of an audio signal that has been segmented into a plurality of fixed-duration segments, each segment constituting a frame, arranged in temporal order.

The term “noise reduction processing” refers to a signal-processing operation that estimates and suppresses noise components within an audio signal while preserving components corresponding to a target sound such as a user's utterance.

The term “directivity control processing” refers to a signal-processing operation that combines signals from a plurality of sensors, such as microphones, to emphasize sound from a particular spatial direction and attenuate sound from other directions.

The term “noise-reduced audio data” refers to audio data that has been processed to attenuate or remove noise components and thereby emphasize a target speech signal.

The term “acoustic feature values” refers to numerical descriptors calculated from an audio signal, including but not limited to spectral coefficients, cepstral coefficients, pitch values, energy values, and temporal-prosodic measures.

The term “time-series vector sequence” refers to a sequence of multi-dimensional vectors indexed or ordered by time, each vector representing features calculated for a corresponding time interval.

The term “imaging detection device” refers to a sensing apparatus such as a camera configured to capture optical information from an environment and to output image signals representing the captured scene.

The term “image signal” refers to data representing spatially sampled optical information of a scene, including digital images or video frames.

The term “face-region detection” refers to an image-processing operation that identifies a region in an image that corresponds to a human face.

The term “size conversion” refers to an image-processing operation that changes the resolution or dimensions of image data while preserving core content.

The term “image data for emotion estimation” refers to processed image data, typically including cropped and resized facial regions, used as input for estimation of a user's emotional state.

The term “associated information” refers to auxiliary data transmitted together with main sensor data and including at least one of vehicle state information, identification information, and time information.

The term “vehicle state information” refers to data indicating an operational condition of a vehicle, including at least one of speed, acceleration, position, orientation, or status of control devices.

The term “identification information” refers to data that uniquely or pseudo-uniquely identifies an entity such as a vehicle, a session, or a user.

The term “time information” refers to data representing temporal attributes such as timestamps or time intervals associated with sensor data or processing events.

The term “predetermined data format” refers to a structured encoding scheme, such as a schema or protocol, used to represent and encapsulate multiple items of data for transmission or storage.

The term “communication interface” refers to a hardware and software combination that enables data exchange between devices or processes via wired or wireless communication.

The term “server function” refers to a logical processing function that receives data from a client or terminal, performs computation or analysis, and returns results, typically executed on one or more computing devices.

The term “speech-recognition machine-learning model” refers to a trained computational model that receives audio data or derived features as input and outputs symbol sequences such as phonemes, words, or character strings corresponding to recognized speech.

The term “character-string data” refers to a sequence of characters encoded according to a character set and representing text, such as a transcription of a user's utterance.

The term “dialect expressions” refers to words, phrases, or linguistic constructions that deviate from a standardized language and are specific to a region, community, or social group.

The term “standardized expressions” refers to language forms that follow formal or widely accepted linguistic norms and are intended to be independent of regional or colloquial variations.

The term “prompt sentence” refers to a text sequence written in natural language that specifies instructions, conditions, constraints, or desired output formats to guide operation of a generative AI model.

The term “generative AI model” refers to a machine-learning model trained on large amounts of data and configured to generate new data, such as text, based on input tokens and instructions.

The term “standardized-language text” refers to text in which dialect expressions and region-specific expressions have been converted into standardized linguistic forms following established language rules.

The term “emotion recognition function” refers to processing that estimates an emotional state of a user based on one or more modalities including speech, text, and images.

The term “dialogue-history information” refers to data representing past interactions, utterances, or system responses in a multi-turn conversation between a user and a system.

The term “preprocessed multimodal data” refers to data from multiple modalities, such as audio, text, and images, that has undergone preliminary processing and is ready for use by a machine-learning model.

The term “emotion-classification machine-learning model” refers to a trained computational model that receives features derived from one or more modalities and outputs discrete emotion categories and/or numerical emotion scores.

The term “emotion-state data” refers to information representing an estimated emotional condition of a user, including at least one of a categorical label, an intensity value, and an urgency-related measure.

The term “emotion category” refers to a classification label representing a type of emotion, such as anxiety, joy, anger, calmness, or urgency.

The term “emotion intensity” refers to a numerical value indicating a strength or magnitude of an estimated emotion.

The term “urgency index” refers to a numerical value indicating a perceived level of urgency or time-criticality associated with a user's emotional state or request.

The term “driving-instruction generation function” refers to processing that generates instructions or policies for vehicle driving behavior based on user input, emotional state, and environment information.

The term “driving action sequence” refers to an ordered list of planned vehicle maneuvers, such as deceleration, turning, lane changes, and intersection traversals.

The term “speed policy” refers to a set of rules or parameters specifying allowable speeds, maximum speeds, or speed profiles for a vehicle under certain conditions.

The term “route policy” refers to a set of rules or preferences specifying which paths, lanes, or maneuvers are to be selected in order to reach a destination or fulfill user instructions.

The term “explanation text” refers to natural-language text describing to a user the rationale, strategy, or details of system actions such as vehicle driving behavior.

The term “surrounding-environment information” refers to data representing an external situation around a vehicle, including at least one of traffic density, road conditions, signals, obstacles, or weather.

The term “external information source” refers to an information provider outside the terminal, such as a remote server, roadside infrastructure, or a third-party data service, that supplies environment-related data.

The term “driving-instruction information” refers to structured data specifying planned driving actions, speed-related parameters, route-related parameters, and related control attributes for a vehicle.

The term “control-command generation function” refers to processing that converts high-level driving-instruction information into low-level control-command data interpretable by control hardware or control software.

The term “control-command data” refers to structured data that directly or indirectly specifies operational targets or setpoints for actuators controlling a vehicle, such as steering, propulsion, and braking.

The term “electronic control apparatus for vehicle control” refers to hardware and software logic configured to receive control-command data and generate actuator-control signals for a vehicle.

The term “terminal function” refers to a logical processing function executed in proximity to the vehicle, configured to handle local sensor input, preprocessing, control execution, and interaction with a remote server.

The term “travel-control function” refers to processing by which a terminal or control unit plans and executes vehicle motion according to specified trajectories and control parameters.

The term “trajectory-generation computation” refers to a numerical planning procedure that determines a time-parameterized path for a vehicle to follow, subject to constraints such as kinematics, dynamics, and safety margins.

The term “local-control computation” refers to a real-time control procedure that converts a target trajectory or set of motion parameters into low-level actuator commands.

The term “drive apparatus” refers to a mechanism configured to provide propulsion to a vehicle, including motor, engine, or powertrain systems.

The term “steering apparatus” refers to a mechanism configured to control directional orientation of a vehicle, including steering actuators and associated control components.

The term “braking apparatus” refers to a mechanism configured to decelerate or stop a vehicle, including braking actuators and associated control components.

The term “guidance-output function” refers to processing that generates and outputs information to a user, such as spoken guidance or visual indications, based on internal state or server-provided explanation text.

The term “voice-synthesis program” refers to software configured to convert text input into synthetic audio output representing spoken language.

The term “synthetic audio” refers to audio data generated by an algorithm or model rather than by direct recording of human speech.

The term “acoustic output device” refers to hardware configured to convert electrical audio signals into audible sound, such as a loudspeaker or headphone.

In one embodiment, a system includes a terminal mounted in a vehicle and a server connected to the terminal via a communication network. The terminal and the server each comprise at least one processor, a memory, and input/output interfaces. The terminal executes sensor acquisition, signal preprocessing, and vehicle-control functions, and the server executes speech recognition, dialect-to-standard conversion, multimodal emotion recognition, and driving-instruction generation using a generative AI model controlled by a prompt sentence.

The terminal includes an acoustic detection device such as a microphone array, an imaging detection device such as an in-cabin camera, and an interface to vehicle electronic control apparatuses. The terminal executes an operating system, for example a real-time operating system or a general-purpose operating system such as a Linux-based operating system. The terminal loads and executes audio-processing programs, image-processing programs, network-communication programs, and automated-driving control programs.

The server includes one or more computing devices provided with processors and graphics processing units. The server executes a server operating system, application-server software implementing an HTTP-based API or a remote procedure call service, a speech-recognition engine, an emotion-recognition engine, and a driving-instruction generation engine. The server also executes an inference engine for a generative AI model, for example a transformer-based language model implemented by a framework such as a neural-network library and deployed via a model-serving component.

The terminal uses a microphone array to obtain an audio signal corresponding to a user's utterance in the vehicle interior. The terminal uses an audio codec to sample the analog audio signal at a predetermined sampling frequency and bit depth and to produce pulse-code-modulated audio samples. The terminal divides the audio samples into overlapping frames and stores the frames as a frame-sequence audio data structure in memory. The frame-sequence audio data is represented, for example, as a two-dimensional array with a time index and a sample index.

The terminal applies signal-processing operations to the frame-sequence audio data using a signal-processing library such as a fast-Fourier-transform library or a digital-signal-processing library. The terminal performs a short-time Fourier transform on each frame, estimates a noise spectrum for stationary noise sources such as engine noise and road noise, and applies a spectral-subtraction or Wiener filter to reduce the energy of the noise spectrum. The terminal also uses beamforming algorithms, such as delay-and-sum beamforming, based on known positions of microphones and an estimated direction of arrival of the user's voice, to form a spatial filter that emphasizes audio from the user's direction. By applying these nontrivial signal-processing sequences on the terminal side, the system reduces the amount of noisy or redundant information that must be transmitted to the server and improves the signal-to-noise ratio before machine-learning inference, thereby improving recognition accuracy and reducing server compute load.

The terminal computes acoustic feature values from the noise-reduced audio data. The terminal applies a windowing function to each frame and computes Mel-frequency cepstral coefficients, fundamental frequency, energy, and spectral-shape indicators. The terminal organizes these acoustic feature values into a time-series vector sequence and stores the sequence as a structured array in memory. The terminal thereby converts raw waveform samples into a compact, information-rich representation, which reduces communication bandwidth and stabilizes downstream emotion estimation.

The terminal uses the in-cabin camera to capture video frames that include the user's face. The terminal executes an image-processing library such as a general-purpose computer-vision library to perform face detection. In one example, the terminal applies a convolutional-neural-network-based detector or a classical cascade classifier to identify a bounding box of a face region. The terminal then crops the face region from the original image, resizes the cropped image to a predetermined resolution such as 224-by-224 pixels, and encodes the resized image using a compression format such as JPEG. The terminal stores the resulting face image data as emotion-estimation image data.

The terminal encodes the noise-reduced audio data, the time-series vector sequence of acoustic feature values, the face image data, and associated information such as vehicle state information, identification information, and time information into a predetermined data format. In one example, the terminal uses a structured text format or a binary serialization format to produce a single message structure that contains distinct fields for each data type. The terminal transmits the message to the server via a network interface such as a mobile communication module or a wireless local-area network module. By performing heavy signal preprocessing and feature extraction on the terminal, the system reduces network traffic volume and latency and enables real-time operation even under limited bandwidth.

The server receives the message via an API endpoint, decodes the structured format, and separates audio data, acoustic-feature data, image data, and metadata. The server invokes a speech-recognition engine, which can be based on a neural network architecture such as a recurrent neural network with an attention mechanism or a transformer encoder-decoder model trained with a connectionist temporal classification loss or sequence-to-sequence loss.

The server converts the noise-reduced audio data into a sequence of linguistic tokens and outputs character-string data representing the recognized utterance. The recognized utterance may include dialect expressions or region-specific traffic expressions.

The server treats the character-string data as dialect text and executes a dialect conversion function. The server constructs a prompt sentence in natural language that instructs a generative AI model to normalize dialect expressions to standardized expressions. In one example, the server generates the following prompt sentence:

“You are a Japanese dialect conversion assistant.

The following text may include Japanese regional dialects and local traffic terms.

Convert this text into standard Japanese imperative sentences that an automated vehicle can easily understand.

Do not change the meaning; you may keep the politeness level.

Input text: “I'm kinda scared, so just take it easy, alright? Turn right at the next light, then go on through the rotary.”

The server concatenates this prompt sentence with the recognized dialect text, converts the text into a token sequence using a tokenizer, and inputs the token sequence into the generative AI model. The generative AI model may be a transformer-based language model with multiple self-attention layers, feed-forward layers, and layer-normalization layers, trained on large-scale text data and fine-tuned for instruction following. The server executes an inference process that propagates activations through the model layers and generates output tokens sequentially according to a probability distribution defined by the model weights.

The server decodes the output tokens into standardized-language text, for example:

“I'm a little scared, so please go slowly. Turn right at the next traffic light, and then pass through the roundabout ahead.” By controlling the generative AI model through the prompt sentence, the server can change normalization rules and output style without retraining the model or modifying the model weights. This architecture improves maintainability and scalability compared with a monolithic, fixed speech-recognition model that encodes dialect normalization internally. It also allows the server to inject domain-specific constraints, such as preserving imperative form and meaning, as explicit tokens in the prompt sentence, which improves deterministic behavior and reduces semantic errors.

The server also performs emotion recognition by combining standardized-language text, acoustic-feature time-series data, and face image data. The server may use a feature-extraction network for images, such as a convolutional neural network that outputs an embedding vector representing facial expression. The server may compute summary statistics of the acoustic-feature time series, such as mean and variance of pitch, distribution of energy, and speech-rate measures. The server then composes a prompt sentence that describes these extracted characteristics in natural language and requests an emotion classification in a structured format. In one example, the server generates the following prompt sentence: “You are an emotion analysis engine for conversational speech.

From the following information, estimate the speaker's main emotional state and its intensity as numerical values.

The output must contain “emotion_label” (e.g., joy, anger, anxiety, urgency, calm), “emotion_intensity” (0.0-1.0), and “urgency_score” (0.0-1.0).

### [Summary of Acoustic Features]

Mean pitch: relatively low, pitch variation: small
Energy: medium
Speech rate: slightly slow

### [Utterance Text (Standard Japanese)]

“I'm a bit scared, so take it slow. Turn right at the next light and go through the roundabout ahead.”

### [Conversation History Summary]

“This is the first ride, and the user is not accustomed to automated driving.”

The server converts this prompt sentence, including the feature summaries, into tokens and inputs them into a generative AI model or into a model comprising separate encoders for text and features followed by a classification head. The server obtains emotion-state data in a structured manner, such as a label “anxiety,” an intensity value, and an urgency index. In an alternative embodiment, the server uses a dedicated emotion-classification model which receives numerical features directly as input and outputs probabilities over predefined emotion classes, thereby providing a more compact and deterministic form of emotion estimation.

The server acquires surrounding-environment information from an external information source such as a traffic information service or a cloud-based map service. The surrounding-environment information may include current traffic density, road surface conditions, and the presence of intersections or roundabouts. The server summarizes this environmental context into descriptive text or structured attributes.

The server generates a further prompt sentence for driving-instruction generation. This prompt sentence specifies that the generative AI model should obey traffic rules, prioritize safety, and consider the estimated emotional state of the user when generating driving policies and explanations. In one example, the server generates the following prompt sentence: “You are a driving-instruction generation engine for an automated vehicle.

Obey all traffic rules and prioritize safety, while also considering the user's emotional state when generating driving instructions.

The output must include “action_sequence”, “speed_policy”, “route_policy”, and “explanation_for_user”.

### [User Instruction]

“I'm feeling a little uneasy, so let's go slowly. Please turn right at the next signal and continue through the roundabout beyond it.”

### [Emotion State]

emotion_label: anxiety, emotion_intensity: 0.85, urgency_score: 0.10

### [Traffic Situation Summary]

“Traffic ahead is moderate, and the road surface condition is good.”

The server inputs this prompt sentence into the generative AI model, which outputs a structured description of a driving action sequence, a speed policy, a route policy, and an explanation text. For example, the generative AI model may output that the next intersection should be approached with gradual deceleration, that a right turn should be executed smoothly when the signal is green and the intersection is clear, and that roundabout entry should occur only when sufficient gaps between vehicles are available. The generative AI model may also specify that maximum speed should be reduced below the usual limit and that acceleration and deceleration rates should be bounded to avoid sudden changes. The explanation text may state that the vehicle will slow down for safety and will check surrounding vehicles carefully before entering the roundabout, providing reassurance to the user.

The server converts the high-level driving-instruction information into control-command data suited for an electronic control apparatus in the vehicle. The server maps each high-level action to numerical control parameters, such as target speed profiles over distance or time, maximum allowed accelerations, and constraints on steering angles or yaw rates. The server encodes these parameters in a message format recognized by the terminal, separating fields for maneuver lists, speed limits, and other control variables. The server transmits this control-command data and the explanation text to the terminal.

The terminal receives the control-command data and explanation text and decodes the structured message. The terminal interfaces with an automated-driving control program that performs trajectory planning and local control. The terminal computes a trajectory that satisfies the speed policy and maneuver sequence specified by the server while also complying with local sensor data and actuation capabilities. The terminal may employ a model-predictive-control algorithm or a sampling-based planner to produce a feasible trajectory, and may apply a feedback control loop to convert the planned trajectory into actuator-control signals for the drive apparatus, steering apparatus, and braking apparatus. The terminal also executes a voice-synthesis program that converts the explanation text into synthetic audio data. The terminal outputs the synthetic audio through a speaker in the vehicle cabin to inform the user of the upcoming maneuvers and safety measures.

By integrating terminal-side preprocessing with server-side generative reasoning in this way, the system achieves multiple technical improvements. The terminal reduces raw data volume and noise, which lowers communication bandwidth demands and improves recognition accuracy. The server uses explicit prompt sentences to control the behavior of the generative AI model, which reduces the need for repeated retraining and enables dynamic configuration of processing policies. The architecture uses specific data structures, such as time-series vector sequences for acoustic features and structured control-command messages, to enable efficient computation and predictable behavior. The combination of dialect-normalizing prompt sentences, multimodal emotion prompts, and driving-instruction prompts provides a non-conventional, multi-stage reasoning pipeline that is specialized to vehicle control rather than a general conversational response.

The system does not merely automate a human cognitive process; instead, the system implements a computational pipeline that exploits specific numeric features, model architectures, and network-based decomposition of tasks to enhance processing speed, recognition accuracy, and control safety beyond what a human operator could perform in real time. The server separates language-level constraints into prompt sentences, which allows the same generative AI model to be reused for distinct subtasks by changing prompts, improving resource utilization on the server. The terminal-server split also allows the system to adapt to hardware constraints: computationally intensive neural-network inference for dialect conversion and driving instruction runs on high-performance server hardware, while latency-sensitive signal processing and control run on the terminal close to the vehicle actuators.

In alternative embodiments, the server may use different neural-network architectures, such as encoder-only or decoder-only transformers, or may use separate models for dialect conversion, emotion recognition, and driving-instruction generation. The server may also employ different feature sets, such as additional prosodic features or gaze-direction features from image data, and may refine prompt sentences to include explicit numerical thresholds or safety rules. The terminal may use different sensor configurations, such as multiple cameras or additional microphones, and may implement different trajectory-planning methods. In each case, the system maintains the core concept that the server constructs and supplies prompt sentences to a generative AI model to perform dialect normalization, emotion estimation, and driving-instruction generation, and that the terminal executes pre- and post-processing steps to reduce computational and communication overhead and to control physical vehicle mechanisms in accordance with the server-generated instructions.

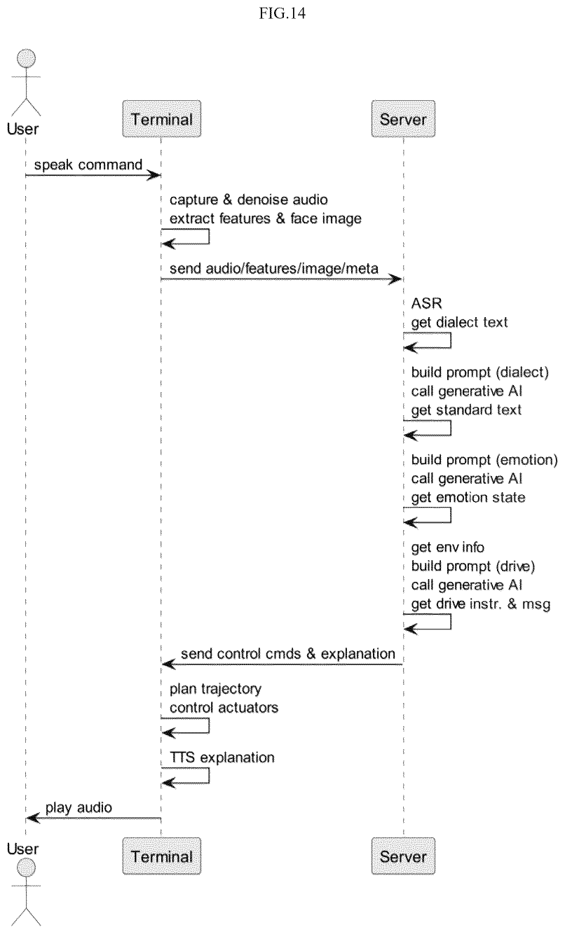

The following describes the processing flow using FIG. 14.

### Step 1:

User issues a voice command inside the vehicle.

User provides, as input, a spoken instruction that may include dialect or region-specific traffic terms, for example: “I'm kinda scared, so just take it easy, alright? Turn right at the next light, then go on through the rotary.“ ”

User produces, as output, an acoustic sound field in the cabin, which becomes the physical input to the terminal's acoustic detection device.

### Step 2:

Terminal acquires and frames audio from the microphone array.

Terminal receives, as input, the analog acoustic signal from a microphone array that captures the user's utterance and ambient noise.

Terminal uses an audio codec to sample the analog signal at a predetermined sampling frequency and bit depth, converting it into PCM digital samples. Terminal then divides the continuous PCM stream into overlapping frames (for example, 25 ms length, 10 ms shift) and stores the frames in a frame buffer in memory.

Terminal outputs a frame-sequence audio data structure that represents the user's utterance as a time-ordered sequence of frames suitable for digital signal processing.

### Step 3:

Terminal performs noise reduction and beamforming.

Terminal receives, as input, the frame-sequence audio data from Step 2.

Terminal applies a short-time Fourier transform to each frame using a signal-processing library, estimates noise spectra for stationary noises such as engine and road noise, and applies spectral-subtraction or Wiener filtering to attenuate those noise components. Terminal also performs beamforming based on the known positions of the microphones and an estimated user direction, computing weighted sums of microphone signals to form a directional audio stream that emphasizes sound from the user.

Terminal outputs noise-reduced, beamformed audio data in the form of a cleaned frame sequence with enhanced speech components and reduced noise components.

### Step 4:

Terminal extracts acoustic features from the cleaned audio.

Terminal receives, as input, the noise-reduced, beamformed audio data from Step 3.

Terminal applies a window function to each frame, computes Mel-frequency cepstral coefficients, fundamental frequency, frame energy, and other spectral-shape indicators using a speech-processing library, and then arranges these values into a multidimensional feature vector for each frame. Terminal associates each feature vector with its corresponding time index.

Terminal outputs a time-series vector sequence of acoustic feature values representing the temporal evolution of speech characteristics, along with the noise-reduced waveform for later use.

### Step 5:

Terminal captures and preprocesses facial images.

Terminal receives, as input, raw image signals from an in-cabin imaging detection device that captures the user's upper body and face.

Terminal runs an image-processing program to detect a face region in the image by applying a face-detection algorithm such as a convolutional-neural-network-based detector or a cascade classifier. Terminal selects the bounding box corresponding to the user's face, crops that region, resizes it to a predetermined resolution, and compresses the cropped image using an image codec such as JPEG.

Terminal outputs emotion-estimation image data consisting of one or more compressed face images aligned with the time of the user's utterance.

### Step 6:

Terminal packages multimodal data and sends it to the server.

Terminal receives, as input, the noise-reduced audio data, the acoustic feature time-series, the emotion-estimation image data, and associated metadata including vehicle state information, identification information, and time information.

Terminal encodes these data items into a predetermined structured format, such as a binary or text-based message with defined fields for each data type. Terminal uses a network-communication program to construct a request message and transmits the encoded message to the server via a communication interface such as a cellular modem or wireless LAN adapter. Terminal outputs a network packet containing multimodal preprocessed data that forms the input for server-side analysis.

### Step 7:

Server receives and decodes the terminal message.

Server receives, as input, the network packet transmitted by the terminal in Step 6 via an API endpoint or RPC interface.

Server parses the packet according to the predetermined data format, performing decoding or deserialization to reconstruct the noise-reduced audio data, the acoustic feature sequence, the face image data, and the metadata. Server writes each reconstructed element into appropriate internal data structures, such as arrays for features and image buffers for face data.

Server outputs separated and structured internal representations of audio, features, images, and metadata for subsequent server-side processing modules.

### Step 8:

Server performs speech recognition on the audio.

Server receives, as input, the noise-reduced audio data from Step 7.

Server runs a speech-recognition machine-learning model, for example a neural acoustic model combined with a language model, on the audio frames. Server converts the waveform into model-specific features (if needed), feeds them into the network, and performs forward propagation through the neural layers to compute probability distributions over phonemes or characters for each time step. Server decodes these distributions using a decoding algorithm such as beam search or CTC decoding to obtain a sequence of characters or words.

Server outputs character-string data representing the recognized utterance, which may still contain dialect expressions or region-specific vocabulary.

### Step 9:

Server generates a prompt sentence for dialect-to-standard conversion.

Server receives, as input, the character-string data from Step 8.

Server constructs a natural-language instruction that describes how to convert dialect expressions into standardized-language text while preserving meaning and politeness level.

Server embeds the recognized text in a template that defines the task. For example, Server generates the following prompt sentence:

“You are a Japanese dialect conversion assistant.

The following text may include Japanese regional dialects and local traffic terms.

Convert this text into standard Japanese imperative sentences that an automated vehicle can easily understand.

Do not change the meaning; you may keep the politeness level.

Input text: “I'm kinda scared, so just take it easy, alright? Turn right at the next light, then go on through the rotary.”

Server outputs this prompt sentence as a textual instruction and combines it with the dialect-containing character-string data to form the input for the generative AI model.

### Step 10:

Server executes the generative AI model for dialect normalization.

Server receives, as input, the prompt sentence and the dialect character-string data from Step 9.

Server tokenizes the combined text, feeds the token sequence into a transformer-based generative AI model, and executes forward passes through multiple attention and feed-forward layers. Server uses the model's output probabilities to generate a sequence of output tokens corresponding to standardized expressions. The generative AI model applies learned mapping rules encoded in its parameters, influenced by the textual constraints in the prompt sentence.

Server outputs standardized-language text, such as “I'm feeling a little uneasy, so let's go slowly. Please turn right at the next signal and continue through the roundabout beyond it.” which is a normalized representation of the user's intention.

### Step 11:

Server prepares multimodal features for emotion recognition.

Server receives, as input, the acoustic-feature time-series, the emotion-estimation image data, the standardized-language text from Step 10, and dialogue-history information if available. Server computes summary statistics over the acoustic features, such as mean and variance of pitch, distribution of energy, and overall speech rate. Server may also apply a pre-trained image feature extractor to the face images to obtain an embedding vector that quantifies facial expression. Server translates these numerical summaries into concise descriptive phrases, for example “Mean pitch: relatively low, pitch variation: small; Energy: medium; Speech rate: slightly slow; Facial expression: worried.”

Server outputs a multimodal feature summary in both numerical and textual form that will be incorporated into a prompt sentence for emotion analysis.

### Step 12:

Server generates a prompt sentence for emotion recognition.

Server receives, as input, the multimodal feature summary and the standardized-language text from Step 11.

Server constructs a natural-language instruction that specifies the required output format for emotion-state data. Server embeds the acoustic-feature summary, the standardized utterance, and a brief dialogue-history summary in the prompt. For example, Server generates the following prompt sentence:

“You are an emotion analysis engine for conversational speech.

From the following information, estimate the speaker's main emotional state and its intensity as numerical values.

The output must contain “emotion_label” (e.g., joy, anger, anxiety, urgency, calm), “emotion_intensity” (0.0-1.0), and “urgency_score” (0.0-1.0).

[Summary of acoustic features]
Mean pitch: relatively low, pitch variation: small
Energy: medium
Speech rate: slightly slow

### [Utterance Text (Standard Japanese)]

“I'm feeling a little uneasy, so let's go slowly. Please turn right at the next signal and continue through the roundabout beyond it.”

### [Conversation History Summary]

“This is the first ride, and the user is not accustomed to automated driving.”

Server outputs this prompt sentence combined with the summarized feature content as the textual input for emotion estimation.

### Step 13:

Server executes an emotion-recognition model to estimate the user's emotional state.

Server receives, as input, the emotion-analysis prompt sentence from Step 12 and, in some implementations, direct numerical features derived from the acoustic and image data.

Server inputs the textual prompt into a generative AI model or, alternatively, concatenates the numerical features with a text embedding and feeds the combined representation into a multimodal neural network with a classification head. Server computes forward passes to produce probabilities or scores for different emotion categories and associated intensities. Server then post-processes the raw scores into a structured output with fields for “emotion_label,” “emotion_intensity,” and “urgency_score.”

Server outputs emotion-state data, for example emotion_label=“anxiety,” emotion_intensity =0.85, urgency_score=0.10, which quantifies the user's current emotional condition.

### Step 14:

Server collects and summarizes surrounding-environment information.

Server receives, as input, environment data from an external information source, such as current traffic density, road type, presence of an intersection, and road-surface conditions.

Server processes this environment data by selecting relevant attributes for the upcoming maneuvers and summarizing them in a concise descriptor. For example, Server may determine that traffic density is “moderate” and that road conditions are “good,” and that no incidents are reported near the next intersection.

Server outputs a textual or structured environment summary describing the context in which driving instructions must be generated.

### Step 15:

Server generates a prompt sentence for driving-instruction generation.

Server receives, as input, the standardized-language text from Step 10, the emotion-state data from Step 13, and the environment summary from Step 14.

Server constructs a prompt sentence that instructs a generative AI model to produce a structured driving action sequence, speed policy, route policy, and user explanation. Server embeds the user instruction, emotional state, and traffic situation into the prompt. For example, Server generates the following prompt sentence:

“You are a driving-instruction generation engine for an automated vehicle.

Obey all traffic rules and prioritize safety, while also considering the user's emotional state when generating driving instructions.

The output must include “action_sequence”, “speed_policy”, “route_policy”, and “explanation_for_user”.

### [User Instruction]

“I'm feeling a little uneasy, so let's go slowly. Please turn right at the next signal and continue through the roundabout beyond it.”

### [Emotion State]

emotion_label: anxiety, emotion_intensity: 0.85, urgency_score: 0.10

### [Traffic Situation Summary]

“Traffic ahead is moderate, and the road surface condition is good.”

Server outputs this driving-instruction prompt sentence as the textual control input for the generative AI model.

### Step 16:

Server executes the generative AI model to generate driving instructions and explanation text.

Server receives, as input, the driving-instruction prompt sentence from Step 15.

Server tokenizes the prompt sentence and feeds the token sequence into the generative AI model. Server then performs inference to generate output tokens representing a structured description of an action_sequence, a speed policy, a route policy, and an explanation_for_user. The generative AI model uses internal learned parameters to map the combination of user intent, emotional state, and environment summary into a set of context-appropriate driving decisions and explanation phrases.

Server outputs driving-instruction information, such as a step-by-step sequence of maneuvers and associated speed constraints, and explanation-text data intended for the user.

### Step 17:

Server converts high-level driving instructions into low-level control-command data.

Server receives, as input, the driving-instruction information and explanation-text data from

### Step 16.

Server parses the high-level description to extract discrete actions, speed limits, acceleration bounds, and route constraints. Server maps these into numerical parameters and encodes them into a control-command message with fields such as maximum speed, maximum acceleration, maneuver list, and target points for turns or roundabout entry. Server attaches the explanation-text data as a separate field in the same message or in an associated message.

Server outputs control-command data and explanation-text data in a format interpretable by the terminal's vehicle-control interface.

### Step 18:

Terminal receives and decodes control-command data and explanation text.

Terminal receives, as input, the structured control-command data and explanation-text data transmitted by the server in Step 17.

Terminal decodes the message format to recover numerical control parameters and the natural-language explanation text. Terminal forwards the control parameters to an automated-driving control program and forwards the explanation text to a voice-synthesis program.

Terminal outputs internal control parameters for trajectory planning and a text string ready for speech synthesis.

### Step 19:

Terminal plans a vehicle trajectory and controls vehicle actuators.

Terminal receives, as input, the control parameters from Step 18 and current sensor readings describing vehicle state and surroundings.

Terminal executes a trajectory-planning algorithm that computes a path and speed profile satisfying the given speed policy and maneuver sequence while respecting dynamic constraints and sensor-derived safety margins. Terminal then runs a local-control algorithm, such as a model-predictive controller or PID controllers, to convert the planned trajectory into actuator commands for the drive apparatus, steering apparatus, and braking apparatus. Terminal sends these low-level actuation commands over an in-vehicle network to the electronic control apparatuses.

Terminal outputs real-time control signals that cause the vehicle to execute smooth deceleration, right turn, and roundabout traversal in accordance with the server-generated instructions and the user's emotional state.

### Step 20:

Terminal synthesizes and outputs the user explanation audio.

Terminal receives, as input, the explanation-text data from Step 18.

Terminal passes the explanation text to a voice-synthesis program that converts the text into synthetic audio by applying a text-to-speech model. Terminal then sends the resulting audio samples to an acoustic output device such as an in-cabin speaker. The synthesized speech informs the user about the planned driving behavior and safety measures.

Terminal outputs audible guidance that reassures the user and explains the vehicle's actions in real time.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

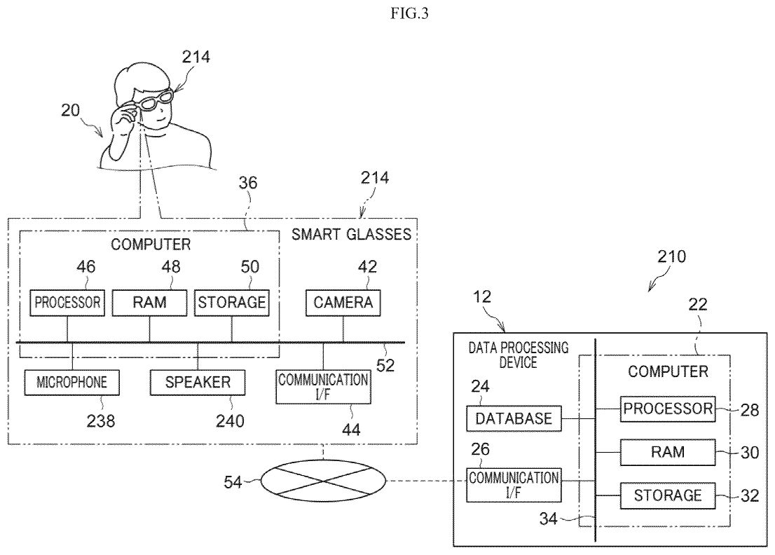

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

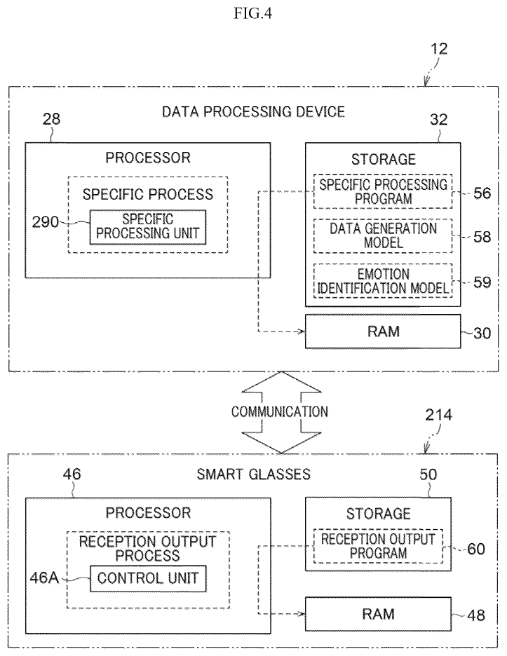

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

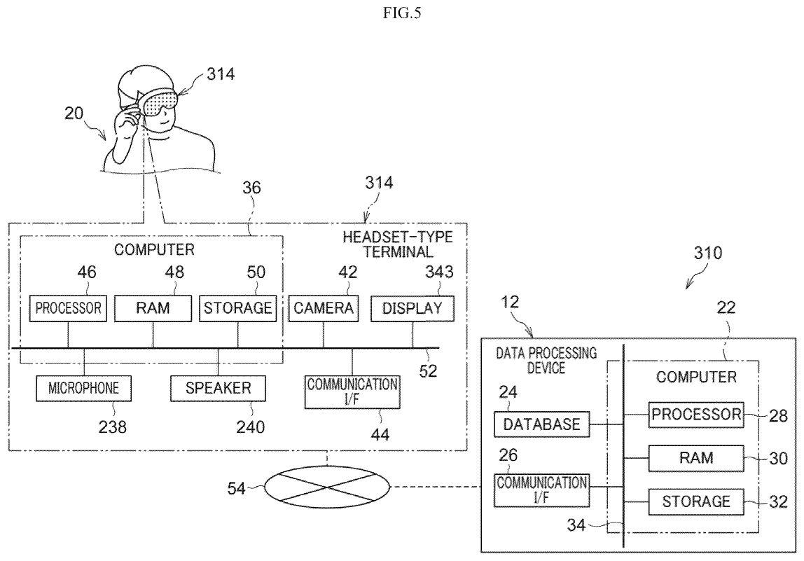

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

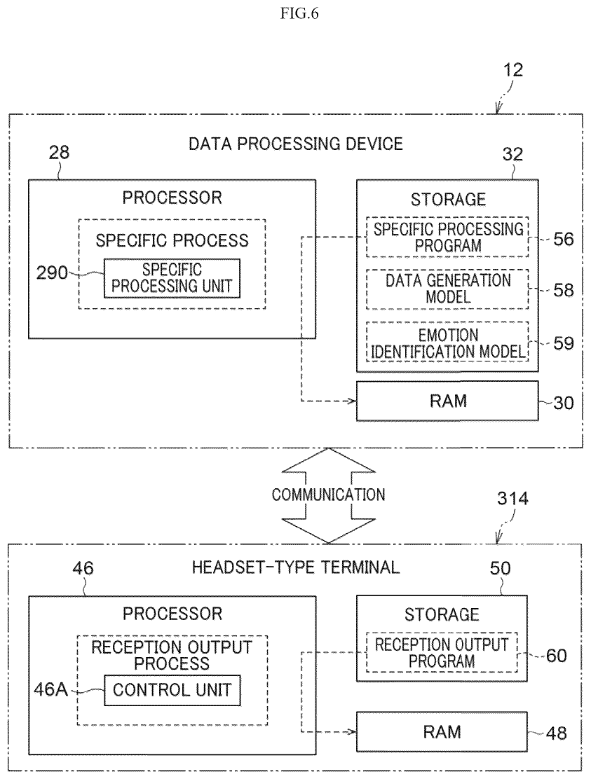

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

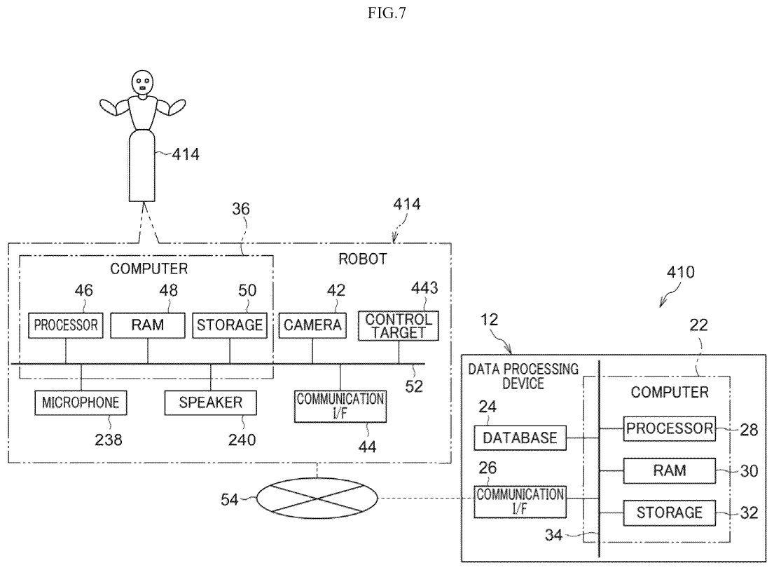

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

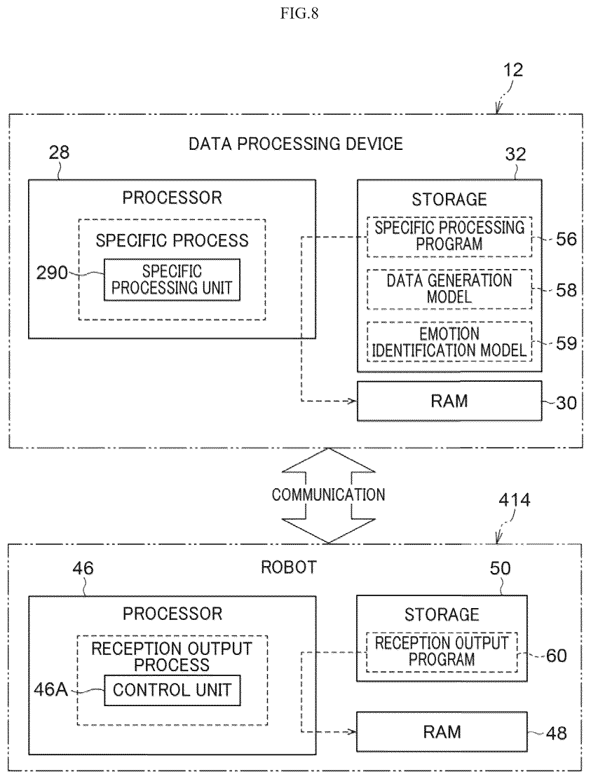

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

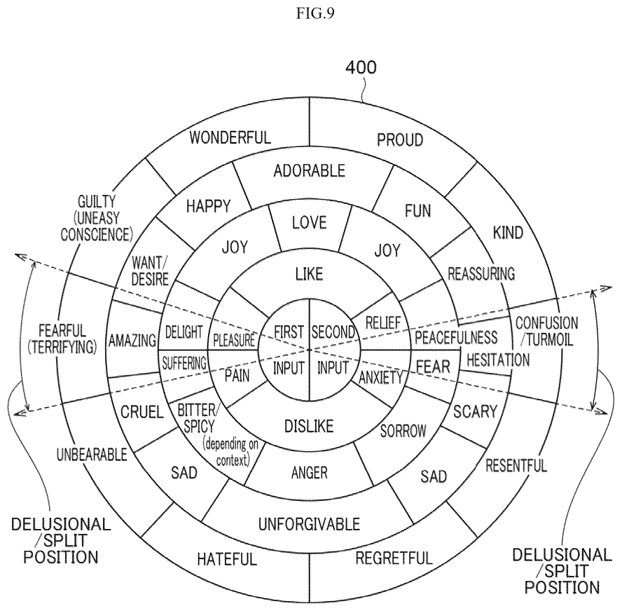

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

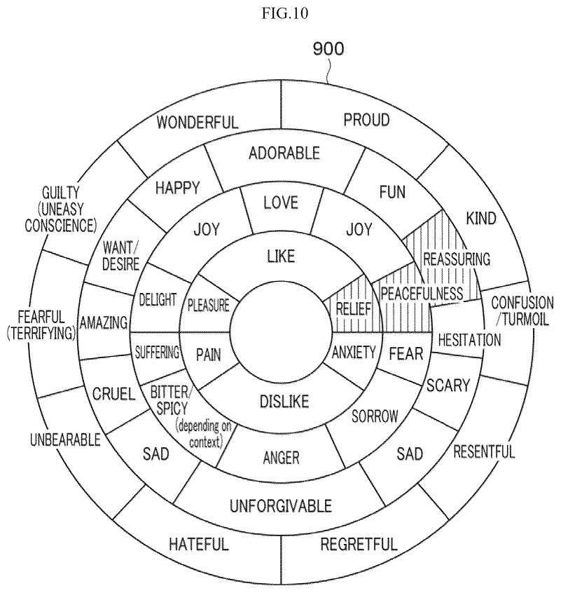

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire, by an audio input unit of a terminal device, audio information representing a user utterance, and transmit the audio information from the terminal device to an information processing device via a communication network,
convert, by the information processing device, the audio information into dialect text information, generate a first prompt sentence for a generative AI model so as to convert a dialect contained in the dialect text information into a standard language, and cause the generative AI model to generate standard-language text information based on the dialect text information and the first prompt sentence,
obtain, by the information processing device, context information including a user intention, user information, and dialogue history information based on the standard-language text information, generate a second prompt sentence including the context information for the generative AI model, and cause the generative AI model to generate a response sentence based on the standard-language text information and the second prompt sentence, transmit, by the information processing device, the response sentence or audio information based on the response sentence to the terminal device via the communication network, convert, by an audio output unit of the terminal device, the response sentence into synthesized speech with controlled emotion and intonation, and output the synthesized speech through a speaker of the terminal device, and
store, by the information processing device, processing history including at least one of speech recognition processing, dialect conversion processing, intention estimation processing, and response generation processing, and update at least one of the generative AI model and at least one of the first prompt sentence and the second prompt sentence based on accumulated processing history.

### (Supplementary 2)

The system according to supplementary 1,
wherein the processor is configured to
perform, in dialect recognition processing, analysis at a phoneme level using an acoustic model and a language model each including audio feature information corresponding to a plurality of regions, and generate the first prompt sentence so as to specify at least one of a target region, a dialect type, and a conversion policy for the generative AI model, thereby mapping dialect-specific pronunciation and vocabulary included in the dialect text information to a vocabulary set of the standard language.

### (Supplementary 3)

The system according to supplementary 1,
wherein the processor is configured to
integrate, in response generation processing, the standard-language text information, the user information, the dialogue history information, and environment information acquired from an external information source into the context information, generate the second prompt sentence including the context information for the generative AI model, cause the generative AI model to output the response sentence, and perform filtering on the response sentence with respect to at least one of safety and expression style before supplying the response sentence to the audio output unit.

### Application Example 1

### (Supplementary 1)

A system comprising a processor,
wherein the processor is configured to acquire voice information by using an audio information acquisition unit that includes at least one sound collection device for obtaining utterances of a user,
wherein the processor is configured to analyze acquired voice information and convert region-specific spoken language into standardized spoken language by using a language conversion unit that employs a generative AI model as a generative-type information processing apparatus,
wherein the processor is configured to perform semantic analysis on text information converted into standardized spoken language and extract an intent of the user and instruction content relating to driving operations by using an intent extraction unit that employs a natural language processing apparatus,
wherein the processor is configured to generate driving instruction information representing a travel route and a travel action of a moving body on the basis of the extracted intent and the instruction content by using a driving instruction generation unit,
wherein the processor is configured to calculate travel control quantities of the moving body on the basis of the driving instruction information and surrounding environment information and to control a drive device and a steering device of the moving body by using a driving control unit,
wherein the processor is configured to dynamically generate and input a prompt sentence to the generative-type information processing apparatus by using a prompt generation unit, the prompt sentence including instruction content for converting dialect and region-specific traffic terminology into standardized spoken language and instruction content for generating the driving instruction information from the standardized spoken language, and
wherein the processor is configured to generate response information for explaining a travel plan and a travel reason to the user on the basis of the driving instruction information and a control result of the driving control unit, and to output the response information as natural speech by using an answer output unit that employs speech synthesis technology.

### (Supplementary 2)

The system according to supplementary 1,
wherein the processor is configured to, in the language conversion unit, use a speech recognition apparatus and the generative-type information processing apparatus that are constructed on the basis of learning information including acoustic information and text information corresponding to region-specific spoken language, perform analysis on the acquired voice information on a phoneme unit basis, map region-specific pronunciation and vocabulary to pronunciation and vocabulary of standardized spoken language, and output only the standardized spoken language from the generative-type information processing apparatus in accordance with the prompt sentence generated by the prompt generation unit.

### (Supplementary 3)

The system according to supplementary 1,
wherein the processor is configured to, in the intent extraction unit, input into the generative-type information processing apparatus the text information converted into standardized spoken language together with past dialog history information, user attribute information, and travel environment information, cause the generative-type information processing apparatus to output structured information including intent relating to driving operations, conditions relating to travel priority, and constraint conditions relating to route selection on the basis of the prompt sentence generated by the prompt generation unit, and cause the driving instruction generation unit to determine the travel route and the travel action on the basis of the structured information.

### Example 2

### (Supplementary 1)

A system comprising a processor,
wherein the processor is configured to
acquire an audio signal of a user utterance via an audio input device and generate audio data under predetermined sampling conditions as an audio input unit, and
perform acoustic processing and speech recognition processing on the audio data to generate character string data including a dialect expression, and input the character string data including the dialect expression and a prompt sentence describing conditions for converting the character string data into a standard language to a generative AI model so as to generate standard language text as a dialect recognition unit, and
calculate acoustic feature data including at least a fundamental frequency, an energy value, a spectral characteristic, a speech rate, and a silence duration from the audio data, perform language analysis processing on the standard language text to extract language feature data including at least an emotion expression, a negation expression, and an emphasis expression, and estimate an emotional state of the user based at least on the acoustic feature data and the language feature data as an emotion recognition unit, and
generate, on the basis of the standard language text, the emotional state, and additional information including dialog history information and attribute information, a prompt sentence describing content of the user utterance and the emotional state of the user, input the prompt sentence to the generative AI model so as to generate response text, and control content or expression of the response text according to the emotional state as a response generation unit, and
determine speech synthesis parameter data including at least a speaking rate, a pitch, and a prosody level according to the response text and the emotional state, perform speech synthesis processing based on the response text and the speech synthesis parameter data so as to generate synthesized speech, and output the synthesized speech through an output device as an audio output unit.

### (Supplementary 2)

The system according to supplementary 1,
wherein the processor is configured to
generate a prompt sentence including the acoustic feature data, the language feature data, the dialog history information, the attribute information summarized as a description, and the standard language text, input the prompt sentence to the generative AI model to acquire emotion score data representing an intensity for each of a plurality of emotion categories, and determine a final emotional state by integrating the emotion score data with an output of a machine learning model included in the emotion recognition unit.

### (Supplementary 3)

The system according to supplementary 1,
wherein the processor is configured to
extract, by natural language understanding processing, an intention of the user and important information from the standard language text, generate a prompt sentence including the intention, the important information, the emotional state, and the dialog history information, and input the prompt sentence to the generative AI model to generate the response text, and apply an expression adjustment rule associated with an emotion category and an intensity of the emotion category to the response text and, when necessary, generate a further prompt sentence including an instruction to rewrite the response text into a more empathetic expression and input the further prompt sentence to the generative AI model to acquire rewritten response text.

### Application Example 2

### (Supplementary 1)

A system comprising a processor,
wherein the processor is configured to
acquire, from an acoustic detection device, an audio signal representing utterance of a user, encode the audio signal at a predetermined sampling frequency and bit depth, divide the encoded audio signal into frames, and store the frames as frame-sequence audio data, perform, by using signal-processing computational resources and a signal-processing program, noise reduction processing and directivity control processing on the frame-sequence audio data to generate noise-reduced audio data in which noise components are reduced and audio components from a direction of the user are emphasized, calculate acoustic feature values from the noise-reduced audio data, and structure the acoustic feature values as a time-series vector sequence,
acquire an image signal from an imaging detection device, and perform, by using image-processing computational resources and an image-processing program, face-region detection, cutting-out, size conversion, and compression on the image signal to generate image data for emotion estimation corresponding to a face of the user,
encode the noise-reduced audio data, the time-series vector sequence of the acoustic feature values, the image data for emotion estimation, and associated information including vehicle state information, identification information, and time information into a predetermined data format, and transmit the encoded data to a server function via a communication interface,
execute, as the server function, speech recognition processing that inputs the noise-reduced audio data and outputs character-string data by using a speech-recognition machine-learning model, the character-string data representing a recognized utterance of the user,
execute, as a dialect conversion function of the server function, processing that treats the character-string data as text including dialect expressions, generates a prompt sentence written in a natural language, the prompt sentence defining processing content and output format for converting the dialect expressions into standardized expressions, and inputs the prompt sentence and the character-string data into a generative AI model so that the generative AI model outputs standardized-language text,
execute, as an emotion recognition function of the server function, processing that inputs the standardized-language text, the time-series vector sequence of the acoustic feature values, the image data for emotion estimation, and dialogue-history information, generates a prompt sentence written in a natural language, the prompt sentence describing requirement specifications and output items for estimating an emotional state of the user, and inputs the prompt sentence and preprocessed multimodal data into a generative AI model or an emotion-classification machine-learning model so that the model outputs emotion-state data including an emotion category, an emotion intensity, and an urgency index,
execute, as a driving-instruction generation function of the server function, processing that inputs the standardized-language text, the emotion-state data, and surrounding-environment information acquired from an external information source, generates a prompt sentence written in a natural language, the prompt sentence defining conditions, constraints, and output items for generating a driving action sequence, a speed policy, a route policy, and an explanation text for the user, and inputs the prompt sentence into a generative AI model so that the generative AI model outputs driving-instruction information and explanation-text data for the user,
convert, as a control-command generation function of the server function, the driving-instruction information into control-command data in a format interpretable by an electronic control apparatus for vehicle control, and transmit the control-command data and the explanation-text data to a terminal function via the communication interface, execute, as a travel-control function of the terminal function, processing that receives the control-command data, performs trajectory-generation computation and local-control computation based on a driving action sequence and travel parameters included in the control-command data, and control a drive apparatus, a steering apparatus, and a braking apparatus of a vehicle, and
execute, as a guidance-output function of the terminal function, processing that receives the explanation-text data, inputs the explanation-text data into a voice-synthesis program to generate synthetic audio, and output the synthetic audio to the user via an acoustic output device.

### (Supplementary 2)

The system according to supplementary 1,
wherein the processor is configured to, in the dialect conversion function, generate the prompt sentence in such a manner that the prompt sentence includes conditions to unify dialect expressions and region-specific expressions into standardized imperative expressions, to maintain semantic content, and to maintain a politeness level, and to input the prompt sentence and the character-string data simultaneously into the generative AI model so that the generative AI model normalizes the dialect expressions into the standardized-language text.

### (Supplementary 3)

The system according to supplementary 1,
wherein the processor is configured to, in the emotion recognition function and the driving-instruction generation function, present the standardized-language text, the time-series vector sequence of the acoustic feature values, the image data for emotion estimation, and the surrounding-environment information in a mutually associated manner within the prompt sentences, and cause the generative AI model to execute, in succession, processing for estimating the emotional state of the user as numerical indices and processing for generating, based on the emotional state and the surrounding-environment information, the driving action sequence, the travel parameters, and the explanation text for the user in such a manner that traffic safety, ride comfort, and psychological sense of security are simultaneously taken into account.

What is claimed is:

1. A system comprising:
circuitry configured to:
receive, via a communication interface coupled to a packet-switched network, audio information representing an utterance;
execute speech recognition processing on the audio information to generate text information;
construct a first prompt sentence specifying a conversion policy for a generative AI model, input the first prompt sentence and the text information to the generative AI model, and obtain converted text information;
determine context information comprising at least a user intention and dialogue history information on the basis of the converted text information;
construct a second prompt sentence comprising the context information, input the second prompt sentence and the converted text information to the generative AI model, and obtain a response sentence; and
transmit the response sentence or audio information generated from the response sentence to a user terminal via the packet-switched network.

2. The system according to claim 1, wherein the text information comprises dialect text information containing region-specific expressions, and the first prompt sentence specifies at least one of a target region, a dialect type, and a conversion policy for mapping dialect-specific pronunciation and vocabulary to a vocabulary set of a standard language.

3. The system according to claim 2, wherein the circuitry is further configured to perform analysis at a phoneme level on the audio information using an acoustic model and a language model each trained on audio feature information corresponding to a plurality of regions, and to generate the dialect text information by mapping phoneme sequences to region-specific character representations.

4. The system according to claim 3, wherein the circuitry is further configured to execute the speech recognition processing by extracting acoustic features comprising log-Mel spectrogram frames from the audio information, inputting the acoustic features to a neural network comprising convolutional layers for local feature extraction and self-attention layers for temporal modeling, and decoding an output sequence using beam search constrained by the language model.

5. The system according to claim 1, wherein the context information further comprises user attribute information and environment information acquired from an external information source, and the second prompt sentence includes at least a portion of the user attribute information and the environment information.

6. The system according to claim 5, wherein the circuitry is further configured to determine the user intention by inputting tokenized converted text information to a transformer encoder that outputs an intention vector representation, and classifying the intention vector representation into at least one of a plurality of intention categories.

7. The system according to claim 6, wherein the circuitry is further configured to execute filtering processing on the response sentence with respect to at least one of safety and expression style by applying a rule-based post-processing module that examines the response sentence for prohibited terms, inappropriate expressions, or excessive length, and re-invoking the generative AI model with a revised second prompt sentence when the response sentence does not satisfy a filtering criterion.

8. The system according to claim 1, wherein the generative AI model comprises a transformer architecture including an embedding layer, a plurality of self-attention layers, feed-forward layers, and a projection layer, and the circuitry executes inference by performing tokenization on the first prompt sentence and the text information, computing attention over a combined token sequence, and decoding output token probabilities into a sequence of tokens.

9. The system according to claim 8, wherein the circuitry is further configured to select a decoding strategy for the generative AI model from at least one of greedy decoding and beam search on the basis of a parameter specified in the first prompt sentence or the second prompt sentence.

10. The system according to claim 1, wherein the circuitry is further configured to generate the audio information from the response sentence by executing a speech synthesis model comprising an encoder-decoder network that converts the response sentence into a mel-spectrogram and a vocoder network that converts the mel-spectrogram into waveform samples, and controlling prosodic parameters comprising at least one of a speaking rate, a pitch, and an energy on the basis of metadata associated with the response sentence.

11. The system according to claim 1, wherein the circuitry is further configured to store processing history comprising at least one of speech recognition processing data, text conversion processing data, intention estimation processing data, and response generation processing data, and to update at least one of a parameter of the generative AI model and at least one of the first prompt sentence and the second prompt sentence on the basis of accumulated processing history.

12. The system according to claim 11, wherein the updating comprises performing fine-tuning of the generative AI model using supervised learning with a loss function comprising a cross-entropy term between a generated token distribution and target text, and updating model weights by gradient-based optimization.

13. The system according to claim 11, wherein the updating comprises analyzing the accumulated processing history to detect systematic conversion errors associated with a particular region, and inserting additional instructions into the first prompt sentence to address the detected conversion errors.

14. The system according to claim 1, wherein the circuitry is further configured to estimate an emotion of a user by applying an emotion identification model to at least one of acoustic feature data derived from the audio information, facial expression data extracted from image information, and text sentiment data derived from the converted text information, and to include an emotion state indicator in the context information.

15. The system according to claim 14, wherein the circuitry is further configured to adjust prosodic parameters of synthesized speech generated from the response sentence on the basis of the estimated emotion, such that when the estimated emotion indicates anxiety, the circuitry reduces a speaking rate and lowers a pitch, and when the estimated emotion indicates excitement, the circuitry increases an energy parameter.

16. The system according to claim 14, wherein the circuitry is further configured to include the emotion state indicator in the second prompt sentence as a constraint, such that the generative AI model generates the response sentence with a tone and vocabulary adapted to the estimated emotion.

17. The system according to claim 1, wherein the circuitry is further configured to perform noise suppression processing and echo cancellation processing on the audio information prior to the speech recognition processing by applying a signal processing algorithm to normalize amplitude and remove stationary noise from the audio information.

18. A system comprising:
circuitry configured to:
receive, via a communication interface operating over a packet-switched network, audio information representing an utterance, and perform noise suppression processing on the audio information by applying a signal processing algorithm;
execute speech recognition processing on the audio information by extracting acoustic features comprising log-Mel spectrogram frames, inputting the acoustic features to a neural network comprising convolutional layers and self-attention layers, and decoding an output sequence using beam search constrained by a language model to generate text information;
construct a first prompt sentence specifying at least one of a target region, a conversion type, and a conversion policy for a generative AI model implemented as a transformer-based language model comprising an embedding layer, a plurality of self-attention layers, feed-forward layers, and a projection layer, input the first prompt sentence and the text information to the generative AI model, and obtain converted text information;
determine a user intention by inputting tokenized converted text information to a transformer encoder and classifying an intention vector representation into at least one of a plurality of intention categories, and integrate the user intention, user attribute information, dialogue history information, and environment information into context information;
construct a second prompt sentence comprising the context information, input the second prompt sentence and the converted text information to the generative AI model, obtain a response sentence, and execute filtering processing on the response sentence with respect to at least one of safety and expression style;
generate audio information from the response sentence by executing a speech synthesis model comprising an encoder-decoder network and a vocoder network with prosodic parameter control; and
transmit the response sentence or the generated audio information to a user terminal via the packet-switched network.

19. The system according to claim 18, wherein the circuitry is further configured to store processing history comprising speech recognition processing data, text conversion processing data, intention estimation processing data, and response generation processing data for each interaction, and to update at least one of a parameter of the generative AI model and at least one of the first prompt sentence and the second prompt sentence on the basis of accumulated processing history by performing fine-tuning using supervised learning with a cross-entropy loss function and gradient-based optimization.

20. A method performed by circuitry of a system, the method comprising:
receiving, via a communication interface coupled to a packet-switched network, audio information representing an utterance;
executing speech recognition processing on the audio information to generate text information;
constructing a first prompt sentence specifying a conversion policy for a generative AI model, inputting the first prompt sentence and the text information to the generative AI model, and obtaining converted text information;
determining context information comprising at least a user intention and dialogue history information on the basis of the converted text information;
constructing a second prompt sentence comprising the context information, inputting the second prompt sentence and the converted text information to the generative AI model, and obtaining a response sentence; and
transmitting the response sentence or audio information generated from the response sentence to a user terminal via the packet-switched network.
